(19) United States
(12) Patent Application Publication
(10) Pub. No.: US 2021/0136674 A1
(43) Pub. Date: May 6, 2021

(54) METHOD AND APPARATUS FOR MANAGING NETWORK SLICES IN WIRELESS COMMUNICATION SYSTEM

(71) Applicant: Samsung Electronics Co., Ltd., Suwon-si (KR)

(72) Inventors: Hoyeon LEE, Suwon-si (KR); Sangsoo JEONG, Suwon-si (KR)

(21) Appl. No.: 17/090,226

(22) Filed: Nov. 5, 2020

(30) Foreign Application Priority Data
Nov. 6, 2019 (KR) 10-2019-0140789
Nov. 15, 2019 (KR) 10-2019-0146955
Apr. 10, 2020 (KR) 10-2020-0043738

(51) Int. Cl. H04W 48/18; H04W 80/10; H04L 29/08; H04W 60/04

(52) U.S. Cl. CPC H04W 48/18; H04W 60/04; H04L 69/327; H04W 80/10

(57) ABSTRACT

A method performed by a network function (NF) in 5G core network (5GC) in a wireless communication system is provided. The method includes receiving, from an application function (AF), an event subscription request message comprising network slice related quota information for a network slice, determining whether an event notification triggering condition for the network slice is met based on the network slice related quota information and data received from at least one NF in the 5GC, and transmitting, to the AF, an event notification message for the network slice based on a result of the determining.

### CROSS-REFERENCE TO RELATED APPLICATION(S)

This application is based on and claims priority under 35 U.S.C. § 119(a) of a Korean patent application number 10-2019-0140789, filed on Nov. 6, 2019, in the Korean Intellectual Property Office, of a Korean patent application number 10-2019-0146955, filed on Nov. 15, 2019, in the Korean Intellectual Property Office, and of a Korean patent application number 10-2020-0043738, filed on Apr. 10, 2020, in the Korean Intellectual Property Office, the disclosure of each of which is incorporated by reference herein in its entirety.

### BACKGROUND

### 1. Field

The disclosure relates to a technology for managing a network slice in a wireless communication system. The disclosure also relates to a method and an apparatus for controlling a data rate per network slice in a wireless communication system.

### 2. Description of Related Art

To meet the increase in demand with respect to wireless data traffic after the commercialization of 4^{th} generation (4G) communication systems, considerable efforts have been made to develop pre-5^{th} generation (5G) communication systems or 5G communication systems. This is one reason why ‘5G communication systems’ or ‘pre-5G communication systems’ are called ‘beyond 4G network communication systems’ or ‘post long-term evolution (LTE) systems.’ In order to achieve a high data transmission rate, 5G communication systems are being developed to be implemented in a super-high frequency band (millimeter wave (mmWave)), e.g., a band of 60 GHz. In order to reduce the path loss of radio waves in such a super-high frequency band and to increase a transmission distance of radio waves in 5G communication systems, various technologies are being studied, for example: beamforming, massive multiple-input multiple-output (MIMO), full dimensional MIMO (FD-MIMO), array antennas, analog beam-forming, and large-scale antennas, and have been discussed. In order to improve system networks for 5G communication systems, various technologies have been developed, e.g., evolved small cells, advanced small cells, cloud radio access networks (Cloud-RAN), ultra-dense networks, device-to-device (D2D) communication, wireless backhaul, moving networks, cooperative communication, coordinated multi-points (CoMP), and interference cancellation. In addition, for 5G communication systems, other technologies have been developed, e.g., hybrid frequency-shift keying (FSK) and quadrature amplitude modulation (QAM) (FQAM) and sliding window superposition coding (SWSC), which are advanced coding modulation (ACM) schemes, and filter bank multi carrier (FBMC), non-orthogonal multiple access (NOMA), and sparse code multiple access (SCMA), which are advanced access schemes.

The Internet has evolved from a human-based connection network, where humans create and consume information, to the Internet of things (IoT), where distributed configurations, such as objects, exchange information with each other to process the information. Internet of everything (IoE) technology is emerging, in which technology related to the IoT is combined with, for example, technology for processing big data through connection with a cloud server. In order to implement the IoT, various technological components are required, such as sensing technology, wired/wireless communication and network infrastructures, service interface technology, security technology, and the like. In recent years, technologies including a sensor network for connecting objects, machine to machine (M2M) communication, machine type communication (MTC), and the like, have been studied. In the IoT environment, intelligent Internet technology (IT) services may be provided to collect and analyze data obtained from objects connected to each other to create new value in human life. As existing information technology (IT) techniques and various industries converge and combine with each other, the IoT may be applied to various fields, such as smart homes, smart buildings, smart cities, smart cars or connected cars, smart grids, health care, smart home appliances, high quality medical services, and the like.

Various attempts are being made to apply 5G communication systems to the IoT network. For example, technologies related to sensor networks, M2M communication, MTC, and the like, are being implemented by using 5G communication technology including beam-forming, MIMO, array antennas, and the like. The application of cloud radio access network (RAN) as a big data processing technology described above may be an example of convergence of 5G communication technology and IoT technology.

As described above, various services are able to be provided due to the development of mobile communication systems, and thus, more particularly, there is a need for a method for efficiently managing a network slice.

In addition, as described above, various services may be provided due to the development of wireless communication systems, and thus there is need for methods of smoothly providing such services. More particularly, owing to the development of various ITs, network equipment has evolved into a virtualized network function (NF) as virtualization technology is applied. The virtualized NFs may be implemented in a form of software without physical restrictions to be installed/operated in various types of cloud or data center (DC). Specifically, the NF may be freely expanded or scaled, or installed (initiated) or terminated depending on a service requirement, system capacity, or a network load.

A network slicing technology has been introduced for such various network structures to support various services. The network slicing technology is a technology of logically configuring a network slice as a set of NFs for supporting a specific service and separating the network slice from another slice. One user equipment (UE) may access two or more slices when receiving various services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for effectively providing a service in a wireless communication system.

Another aspect of the disclosure is to provide a method and an apparatus for controlling a data rate per network slice in a wireless communication system.

Additional aspects will be set forth in part in the description which follows and, in part, will be apparent from the description, or may be learned by practice of the presented embodiments of the disclosure.

In accordance with an aspect of the disclosure, a method performed by a network function (NF) in 5G core network (5GC) in a wireless communication system is provided. The method includes receiving, from an application function (AF), an event subscription request message comprising network slice related quota information for a network slice, determining whether an event notification triggering condition for the network slice is met based on the network slice related quota information and data received from at least one NF in the 5GC, and transmitting, to the AF, an event notification message for the network slice based on a result of the determining.

In an embodiment of the disclosure, the network slice related quota information for the network slice comprises at least one of a maximum number of user equipment (UEs) to be registered for the network slice or a maximum number of protocol data unit (PDU) sessions to be established for the network slice.

In an embodiment of the disclosure, the method further comprises storing the network slice related quota information.

In an embodiment of the disclosure, the method further comprises updating quota of the network slice based on the network slice related quota information.

In an embodiment of the disclosure, the method further comprises monitoring a current number of UEs being registered for the network slice, and determining whether the event notification triggering condition for the network slice is met based on the network slice related quota information and a result of the monitoring.

In an embodiment of the disclosure, the method further comprises updating a current number of PDU sessions successfully established for the network slice based on the maximum number of PDU sessions to be established for the network slice.

In an embodiment of the disclosure, the event notification triggering condition comprises at least one of a first condition that a current number of UEs being registered for the network slice is equal to or greater than the maximum number of UEs to be registered for the network slice or a second condition that a current number of PDU sessions successfully established for the network slice is equal to or greater than the maximum number of protocol data unit (PDU) sessions to be established for the network slice.

In an embodiment of the disclosure, the network slice related quota information for the network slice further comprises a maximum data rate for the network slice.

In an embodiment of the disclosure, the NF is a policy control function (PCF).

In an embodiment of the disclosure, the data received from at least one NF in the 5GC comprises at least one of each of a current number of UEs being registered for the network slice and supported by each of the at least one NF, respectively, or each of a current number of PDU sessions successfully established for the network slice and supported by each of the at least one NF, respectively.

In accordance with another aspect of the disclosure, a network function (NF) in 5G core network (5GC) in a wireless communication system is provided. The NF includes a transceiver, and at least one processor operably coupled with the transceiver and configured to control the transceiver to receive, from an application function (AF), an event subscription request message comprising network slice related quota information for a network slice, determine whether an event notification triggering condition for the network slice is met based on the network slice related quota information and data received from at least one NF in the 5GC, and control the transceiver to transmit, to the AF, an event notification message for the network slice based on a result of the determining.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of a 5^{th} generation (5G) system according to an embodiment of the disclosure;

FIG. 2 is a flow diagram of a procedure by which a 5G system obtains slice policy information according to an embodiment of the disclosure;

FIG. 3A is a flow diagram of a procedure by which a 5G system provides managed slice policy information to a network function (NF) of a 5G core network according to an embodiment of the disclosure;

FIG. 3B is a flow diagram of a procedure of storing policy control function (PCF) information supporting a slice policy according to an embodiment of the disclosure;

FIG. 4 is a flow diagram of a procedure by which a 5G system updates managed slice policy information according to an embodiment of the disclosure;

FIG. 5 is a flow diagram of a procedure by which a 5G system updates managed slice policy information according to an embodiment of the disclosure;

FIG. 6 is a flow diagram of a procedure by which a 5G system transmits a monitoring report of managed slice policy information to an application function (AF) according to an embodiment of the disclosure;

FIG. 7 is a flow diagram of a procedure by which a 5G system transmits a monitoring report of managed slice policy information to an AF according to an embodiment of the disclosure;

FIG. 8 is a flow diagram of a procedure by which a 5G system applies a managed slice policy to a plurality of NFs according to an embodiment of the disclosure;

FIG. 9 is a flow diagram for describing a method by which a network function in 5GC manages a network slice in an embodiment of the disclosure;

FIG. 10 is a block diagram of a configuration of a user equipment (UE) according to an embodiment of the disclosure;

FIG. 11 is a block diagram of a configuration of a network entity according to an embodiment of the disclosure.

FIG. 12 is a diagram of a wireless communication system according to an embodiment of the disclosure;

FIG. 13 is a flow diagram for describing a method by which a base station is configured with a data rate of a network slice from a slice manager (operations, administration, and maintenance (OAM) according to an embodiment of the disclosure;

FIG. 14 is a flow diagram for describing a method by which a base station is configured with a data rate of a network slice from an access and mobility management function (AMF) according to an embodiment of the disclosure;

FIG. 15 is a flow diagram for describing a method by which a base station is configured with a data rate of a network slice from a network function (NF) according to an embodiment of the disclosure;

FIG. 16 is a flow diagram for describing a method by which a base station receives information about a network slice from an AMF according to an embodiment of the disclosure;

FIG. 17 is a flow diagram for describing a method by which a base station receives information about a network slice from an NF according to an embodiment of the disclosure;

FIG. 18 is a flow diagram for describing a method by which a base station monitors and reports statuses of a data rate per network slice and data usage according to an embodiment of the disclosure;

FIG. 19 is a block diagram of a configuration of a user equipment (UE) according to an embodiment of the disclosure;

FIG. 20 is a block diagram of a configuration of a base station according to an embodiment of the disclosure; and

FIG. 21 is a block diagram of a configuration of a network entity according to an embodiment of the disclosure.

The same reference numerals are used to represent the same elements throughout the drawings.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used based on in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Advantages and features of one or more embodiments of the disclosure and methods of accomplishing the same may be understood more readily by reference to the following detailed description of the embodiments of the disclosure and the accompanying drawings. In this regard, the embodiments of the disclosure may have different forms and should not be construed as being limited to the descriptions set forth herein. Rather, these embodiments of the disclosure are provided so that the disclosure will be thorough and complete and will fully convey the concept of the disclosure to one of ordinary skill in the art, and the disclosure will only be defined by the appended claims. Throughout the specification, like reference numerals denote like elements.

Here, it will be understood that combinations of blocks in flowcharts or process flow diagrams may be performed by computer program instructions. Because these computer program instructions may be loaded into a processor of a general-purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-executable or computer-readable memory capable of directing a computer or another programmable data processing apparatus to implement a function in a particular manner, and thus the instructions stored in the computer-executable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

Here, the term “unit” in the embodiments means a software component or hardware component, such as a field-programmable gate array (FPGA) or an application-specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components, such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be divided into additional components and “units”. Furthermore, the components and “units” may be embodied to reproduce one or more central processing units (CPUs) in a device or security multimedia card.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, or the like.

In the disclosure, a controller may also be referred to as a processor.

Throughout the specification, a layer (or a layer apparatus) may also be referred to as an entity.

Hereinafter, a base station is an entity that assigns resources of a terminal, and may be at least one of a node B (NB), a base station (BS), a next-generation node B (gNB), an evolved node B (eNB), a wireless access unit, a BS controller, or a node on a network. In addition, embodiments of the disclosure may be applied to other communication systems having a technical background or channel type similar to the embodiments of the disclosure described below. In addition, it will be understood by one of ordinary skill in the art that embodiments of the disclosure may be applied to other communication systems through some modifications without departing from the scope of the disclosure.

In addition, terms for identifying access nodes, terms denoting network entities or network functions (NFs), terms denoting messages, terms denoting an interface between network entities, terms denoting various types of identification information, and the like, used herein are exemplified for convenience of description. Thus, the terms used in the disclosure are not limited and other terms denoting targets having the same technical meanings may be used.

Hereinafter, for convenience of description, the disclosure uses terms and names defined by the 3^{rd} generation partnership project long term evolution (3GPP LTE) and 5^{th} generation (5G) standard. However, the disclosure is not limited by such terms and names, and may be equally applied to systems conforming to other standards.

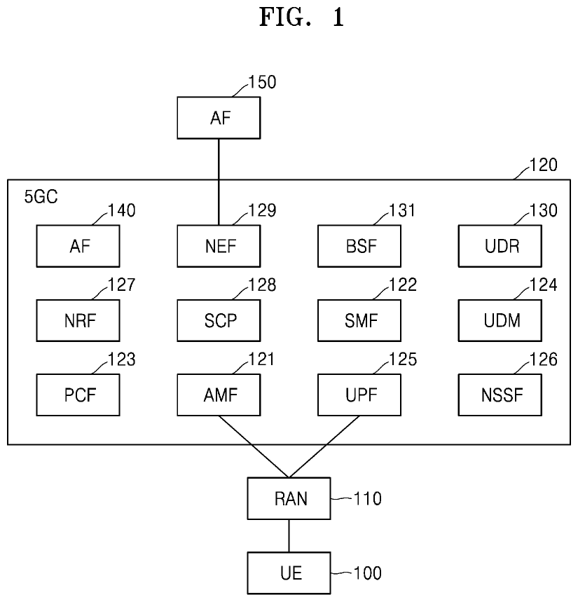

FIG. 1 is a diagram of a 5G system according to an embodiment of the disclosure.

Referring to FIG. 1, the 5G system according to an embodiment of the disclosure may include a UE (or terminal) 100, a base station (i.e., a radio access network (RAN)) 110, a 5G core network (5GC) 120. The 5GC 120 may include network functions (NFs), such as an access and mobility management function (AMF) 121, a session management function (SMF) 122, a policy control function (PCF) 123, unified data management (UDM) 124, a user plane function (UPF) 125, a network slice selection function (NSSF) 126, a network repository function (NRF) 127, a service communication proxy (SCP) 128, a network exposure function (NEF) 129, a unified data repository (UDR) 130, and a binding support function (BSF) 132. According to an embodiment of the disclosure, an NF may denote a network entity (NE) or a network resource. The base station 110 may include a next-generation radio access network (NG-RAN) (hereinafter, interchangeably used with 5G-RAN or RAN), an evolved universal terrestrial RAN (E-UTRAN), or the like. The UE 100 may access the 5GC 120 via the base station 110.

According to an embodiment of the disclosure, the AMF 121 may be an NF of managing access of the UE 100 to a wireless network and mobility of the UE 100.

According to an embodiment of the disclosure, the SMF 122 may be an NF that manages packet data network connection provided to the UE 100. The packet data network connection may be referred to as a protocol data unit (PDU) session. PDU session information may include quality of service (QoS) information, billing information, or information about packet processing.

According to an embodiment of the disclosure, the PCF 123 may be an NF applying, to the UE 100, a service policy, billing policy, and PDU session policy of a mobile carrier.

According to an embodiment of the disclosure, the UPF 125 may function as a gateway delivering a packet transmitted and received by the UE 100 and may be an NF controlled by the SMF 122. The UPF 125 may be connected to a data network (DN) to perform a function of delivering an uplink data packet generated by the UE 100 to an external data network via the 5G system. In addition, the UPF 125 may perform a function of delivering downlink data generated in the external DN to the UE 100 via the 5G system. For example, the UPF 125 may be connected to a DN connected to the Internet so as to route a data packet transmitted from the UE 100 to the Internet or route a data packet transmitted from the Internet to the UE 100.

According to an embodiment of the disclosure, the UDM 124 may be an NF that stores and manages information about a subscriber.

According to an embodiment of the disclosure, the NEF 129 is an NF capable of accessing information of managing the UE 100 by a 5G network, and may be an NF that performs a function of delivering information about the UE 100 to NFs of 5GC by being connected to the NFs thereof or externally reporting the information about the UE 100, via subscription to a mobility management event of the UE 100, subscription to a session management event of the UE 100, a request for session-related information, charging information configuration of the UE 100, or PUD session policy change request regarding the UE 100.

According to an embodiment of the disclosure, the UDR 130 may be an NF that stores and manages data. For example, the UDR 130 may store UE subscription information and provide the UE subscription information to the UDM 124. The UDR 130 may store mobile carrier policy information and provide the mobile carrier policy information to the PCF 123. The UDR 130 may store network service exposure-related information and provide the network service exposure-related information to the NEF 129.

According to an embodiment of the disclosure, the NSSF 126 may be an NF that determines a network slice available to the UE 100 and determines a network slice instance configuring such a network slice.

Each NF defines a service it provides and services provided the NFs may be referred to as Npcf, Nsmf, Namf, Nnef services. For example, when the AMF 121 delivers a session-related message to the SMF 122, the AMF 121 may use a service (or an application program interface (API)) called Nsmf PDUSession_CreateSMContext.

According to an embodiment of the disclosure, application functions (AFs) 140 and 150 may be NFs capable of using a service and function provided by the 5G network. In addition, the AFs 140 and 150 may be application servers. More particularly, the AF 150 may communicate with an NF configuring the 5GC 120 via the NEF 129 or the AF 140 may directly communicate with an NF configuring the 5GC 120 without via the NEF 129. In addition, the AFs 140 and 150 may be located inside the 5CG 120 or in an external network (for example, a network of a third party service provider).

According to an embodiment of the disclosure, the UE 100 may access the AMF 121 via the base station 110 and exchange a control plane signaling message with the 5GC 120. In addition, the UE 100 may access the UPF 125 via the base station 110 to exchange user plane data with the DN. An application server that provides an application layer service to the UE 100 may be referred to as the AF 140 when exchanging the control plane signaling message with the 5GC 120 and referred to as the DN when exchanging the user plane data with the UE 100. In addition, the AF 140 and the DN may be interchangeably used to refer to the application server.

A mobile communication system (wireless communication system) may include a network supporting network slicing. In other words, in the mobile communication system, one physical network may include logically separated network slices (hereinafter, interchangeably used with slices) and may be managed. The mobile carrier may provide dedicated network slices respectively specialized for various services having different characteristics. The network slices may have different types and amounts of required resources depending on service characteristics and the mobile communication system may guarantee a resource required by each network slice. For example, a network slice providing a voice call service may have a high frequency of occurrence of control plane signaling and may be configured by an NF specialized in relation thereto. A network slice providing an Internet data service may have a high frequency of occurrence of massive amount data traffic and may be configured by an NF specialized in relation thereto.

According to an embodiment of the disclosure, in the 5G system defined by 3GPP, one network slice may be referred to as single-network slice selection assistance information (S-NSSAI). The S-NSSAI may include a slice/service type (SST) value and a slice differentiator (SD) value. The SST value may indicate a characteristic (for example, enhanced mobile broadband (eMBB), Internet of things (IoT), ultra-reliable low-latency communications (URLLC), vehicle-to-everything (V2X), or the like) of a service supported by a slice. The SD value may be a value used as an additional indicator for a specific service indicated by the SST value.

NSSAI may include one or more pieces of S-NSSAI. Examples of NSSAI include configured NSSAI stored in a UE, requested NSSAI requested by a UE, allowed NSSAI allowed to be used by a UE determined by an NF (for example, AMF, NSSF, or the like) of a 5GC, and subscribed NSSAI to which a UE is subscribed, but are not limited thereto.

A mobile carrier may define a size (i.e., quota) of network resources providable for each network slices. In the disclosure, such defining may be referred to as a network slice policy or slice policy. Slice policy information may include at least one information of following information. However, the information is not limited thereto.
S-NSSAI
Maximum number of UEs
Maximum number of sessions (e.g., maximum number of PDU sessions or maximum number of PDN connections)
Maximum data rates
Indication whether to enable/disable quota on maximum number of UEs
Indication whether to enable/disable quota on maximum number of sessions
Indication whether to enable/disable quota on maximum data rates
Usage monitoring control condition

The S-NSSAI included in the slice policy information according to an embodiment of the disclosure may be an indicator indicating a slice. The mobile carrier may use network slice instance (NSI) identification (ID) as the indicator indicating the slice, instead of the S-NSSAI.

The maximum number of UEs included in the slice policy information according to an embodiment of the disclosure may indicate the number of UEs allowed to use the S-NSSAI. A UE may transmit, to an AMF, requested NSSAI to be used during a registration procedure or an attach procedure, and the AMF may determine allowed NSSAI available to the UE and provide the allowed NSSAI to the UE. According to an embodiment of the disclosure, the maximum number of UEs may indicate a maximum value of the number of UEs that received the allowed NSSAI including the S-NSSAI during the registration procedure. For example, when the maximum number of UEs of an eMBB slice is one million, a 5GC (or at least one NF in the 5GC) may transmit allowed NSSAI including S-NSSAI indicating the eMBB slice to the maximum one million UEs. However, the disclosure is not limited to the above examples.

The maximum number of sessions included in the slice policy information according to an embodiment of the disclosure may indicate the number of PDU sessions or packet data network (PDN) connections established by using the S-NSSAI. The UE may transmit a session establishment request message to the 5GC (or at least one NF in the 5GC) by including slice information (S-NSSAI) to be used, during a PDU session establishment procedure or PDN connection setup procedure, and the 5GC (or at least one NF in the 5GC) may establish a session by processing a session establishment request of the UE. According to an embodiment of the disclosure, the maximum number of sessions may indicate a maximum value of sessions established via S-NSSAI during the session establishment procedure. For example, when a maximum number of sessions in an eMBB slice is three million, the 5GC (or at least one NF in the 5GC) may allow up to three million for the maximum number of sessions established via S-NSSAI denoting the eMBB slice. However, the disclosure is not limited to the above examples.

The maximum data rates included in the slice policy information according to an embodiment of the disclosure may indicate transmission rates of user plane data transmitted from an established session by using S-NSSAI. For example, when maximum data rates of an eMBB slice is three million terabytes per second (or terabits per second), the 5GC (or at least one NF in the 5GC) may allow up to three million terabytes per second (or terabits per second) for maximum data rates of data transmitted from a session established via S-NSSAI denoting the eMBB slice. However, the disclosure is not limited to the above examples.

Since the maximum number UEs, the maximum number of sessions, and the maximum data rates included in the slice policy information are information on a quota allowed for a slice, they may be classified as slice related quota information. That is, in the disclosure, the slice related quota information may include at least one of the maximum number of UEs, the maximum number of sessions, and the maximum data rates.

The indication whether to enable/disable the quota on the maximum number of UEs included in the slice policy information according to an embodiment of the disclosure may indicate a value in an on/off form or enable/disable form. For example, when a maximum number of UEs is one million and the indication whether to enable/disable the quota on the maximum number of UEs is on or enable, the 5GC (or at least one NF in the 5GC) may allow up to one million UEs to use S-NSSAI. When the indication whether to enable/disable the quota on the maximum number of UEs is off or disable, the 5GC (or at least one NF in the 5GC) may disable the quota on the maximum number of UEs. In other words, more than one million UEs may be allowed to use the S-NSSAI.

The indication whether to enable/disable the quota on the maximum number of sessions included in the slice policy information according to an embodiment of the disclosure may indicate a value in an on/off form or enable/disable form. For example, when a maximum number of sessions is three million and the indication whether to enable/disable the quota on the maximum number of sessions is on or enable, the 5GC (or at least one NF in the 5GC) may allow up to three million sessions to use S-NSSAI. When the indication whether to enable/disable the quota on the maximum number of sessions is off or disable, the 5GC (or at least one NF in the 5GC) may disable the quota on the maximum number of sessions. In other words, more than three million sessions may be allowed to use the S-NSSAI.

The indication whether to enable/disable the quota on the maximum data rates included in the slice policy information according to an embodiment of the disclosure may indicate a value in an on/off form or enable/disable form. For example, when the maximum data rates are three million terabytes per second (or terabits per second) and the indication whether to enable/disable the quota on the maximum data rates is on or enable, the 5GC (or at least one NF in the 5GC) may allow up to three million terabytes per second (or terabits per second) of data to be transmitted from a session using S-NSSAI. When the indication whether to enable/disable the quota on the maximum data rates is off or disable, the 5GC (or at least one NF in the 5GC) may disable the quota on the maximum data rates. In other words, more than three million terabytes per second (or terabits per second) of data may be allowed to be transmitted from the session using the S-NSSAI.

The usage monitoring control condition included in the slice policy information according to an embodiment of the disclosure may include a condition for transmitting a notification message about usage of a network slice referred to as S-NSSAI. The condition for transmitting a notification message about the usage of the network slice may include a number of UEs currently registered, a number of sessions currently used, current data rates, reaching of a maximum number of UEs, reaching of a maximum number of sessions, and reaching of maximum data rates, but is not limited thereto and may include any condition information settable by a mobile carrier or a network slice user.

According to an embodiment of the disclosure, when a maximum number of UEs is one million and a number of UEs for a usage monitoring control condition is 800,000, the 5GC (or at least one NF in the 5GC) may transmit a notification message when a number of UEs allowed to use S-NSSAI reaches 800,000 and transmit a notification message when a number of UEs reaches the maximum number of UEs, i.e., one million.

According to an embodiment of the disclosure, when a maximum number of sessions is three million and a number of sessions for a usage monitoring control condition is 2.5 million, the 5GC (or at least one NF in the 5GC) may transmit a notification message when a number of sessions established via S-NSSAI reaches 2.5 million and transmit a notification message when a number of sessions reaches the maximum number of sessions, i.e., three million.

According to an embodiment of the disclosure, when maximum data rates are three million terabytes per second (or terabits per second) and data rates for a usage monitoring control condition are 2.5 million terabytes per second (or terabits per second), the 5GC (or at least one NF in the 5GC) may transmit a notification message when a transmission rate of data transmitted from a session established via S-NSSAI reaches 2.5 million terabytes per second (or terabits per second) and transmit a notification message when the transmission rate of the data reaches the maximum data rates, i.e., three million terabytes per second (or terabits per second).

The 5GC (or at least one NF in the 5GC) according to an embodiment of the disclosure may store, in an NF, and manage the slice policy information. For example, the PCF 123 among the NFs of the 5GC may manage the slice policy information. In the disclosure, for convenience of description, the PCF 123 manages slice policy information as an example. However, among the NFs of the 5GC, NFs other than the PCF 123 may manage slice policy information, and the description of the management of the slice policy information by the PCF 123 in the disclosure may be applied equally to other NFs.

According to an embodiment of the disclosure, the slice policy information stored in the PCF 123 may be determined by a policy of the mobile carrier. The mobile carrier may store, in the PCF 123, and update the slice policy information via an operation, administration, and maintenance (OAM) method. Alternatively, the slice policy information may be stored and updated in the PCF 123 upon a request of the AF 140 operated by the mobile carrier, and in this case, the AF 140 may directly communicate with the PCF 123.

According to an embodiment of the disclosure, the slice policy information stored in the PCF 123 may be determined by a service level agreement (SLA) between the mobile carrier and a third party service provider. The third party service provider may store, in the PCF 123, and update the slice policy information upon a request of the AF 150 operated by the third party service provider. In this case, the AF 150 may communicate with the PCF 123 via the NEF 129 or may directly communicate with the PCF 123.

The above description referring to FIG. 1 is not limited to a specific part of the disclosure and may be applied to the entire description of the method and apparatus for managing a network slice described in the disclosure.

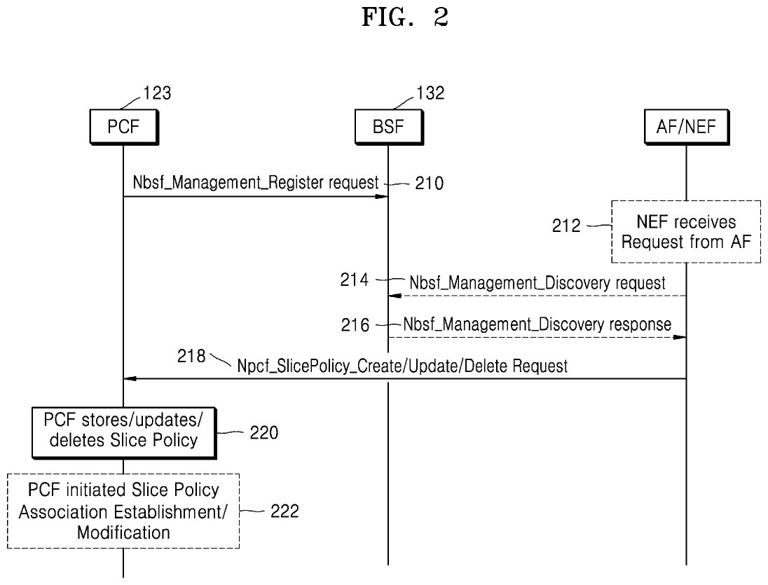

FIG. 2 is a flow diagram of a procedure by which the 5G system obtains the slice policy information according to an embodiment of the disclosure.

Referring to FIG. 2, the PCF 123 according to an embodiment of the disclosure may register slice information (S-NSSAI) supported (served) by the PCF 123 in a binding support function (BSF) 132, in operation 210. For example, the PCF 123 may register the slice information (S-NSSAI) supported by the PCF 123 in the BSF 132 via an Nbsf_Mangement Register request message. Here, a name of the message is not limited to that of FIG. 2.

According to an embodiment of the disclosure, the S-NSSAI may indicate that the PCF 123 stores and manages slice policy information for the S-NSSAI regardless of a session (a PDU session or PDN connection). When the PCF 123 supports one or more pieces of S-NSSAI, the PCF 123 may register the one or more pieces of S-NSSAI in the BSF 132. A register request message (the Nbsf_Mangement Register request message) of operation 210 may include at least one of PCF ID indicating the PCF 123, PCF set ID including the PCF 123, and the one or more pieces of S-NSSAI (i.e., S-NSSAI(s)) supported by the PCF 123. The BSF 132 may store received information.

Referring to FIG. 2, the AFs 140 and 150 of FIG. 1 according to an embodiment of the disclosure may generate an AF request message. The AF request message may include slice policy information according to an embodiment of the disclosure.

The NEF 129 may receive the AF request message from the AF 150 in operation 212.

The NEF 129 may authenticate the AF request message. When the authentication is successful, the NEF 129 may select the PCF 123 supporting (serving) the slice (S-NSSAI), based on the slice information (S-NSSAI) included in the AF request message. For example, the NEF 129 may transmit a discovery request message to the BSF 132 in operation 214. The discovery request message may be an Nbsf_Management Discovery request message. However, a name of the message is not limited thereto. The discovery request message may include the S-NSSAI. The BSF 132 may select the PCF 123 supporting (serving) the S-NSSAI received in operation 214, based on the slice information supported (served) by the PCF 123 and the PCF information (for example, PCF ID, PCF set ID, or the like) stored in operation 210. The BSF 132 may transmit a discovery response message to the NEF 129 in operation 216. The discovery response message may be an Nbsf_Management Discovery response message. However, a name of the message is not limited thereto. The discovery response message may include the PCF information (PCF ID and/or PCF set ID) selected by the BSF 132.

The NEF 129 according to an embodiment of the disclosure may select the PCF 123 supporting (serving) the S-NSSAI included in the AF request message, based on the PCF information received from the BSF 132 in operation 216 or the PCF information stored in the NEF 129. When the PCF information is the PCF ID, the NEF 129 may select the PCF 123 indicated by the PCF ID. When the PCF information is the PCF set ID, the NEF 129 may select one PCF 123 from among PCFs included in a PCF set.

The NEF 129 according to an embodiment of the disclosure may transmit a slice policy request message to the PCF 123 in operation 218. The slice policy request message may be an Npcf_SlicePolicy_Create/Update/Delete request message. However, a name of the message is not limited thereto. The slice policy request message may include the slice policy information included in the AF request message received by the NEF 129 from the AF 150.

In addition, the AF 140 or 150 according to an embodiment of the disclosure may transmit the slice policy request message directly to the PCF 123 without through the NEF 129, in operation 218. The slice policy request message may include the slice policy information generated by the AF 140 or 150.

The PCF 123 according to an embodiment of the disclosure may authenticate the slice policy request message received in operation 218. When the authentication is successful, the PCF 123 may store the received slice policy information, in operation 220. Then, the PCF 123 may perform a slice policy association procedure or a slice policy modification procedure in operation 222. This will be described with reference to the drawings below.

The UDM 124 according to an embodiment of the disclosure may store and manage UE subscription information. The UE subscription information may include subscription slice information (subscribed S-NSSAI) available to a UE. When there is slice policy information associated with S-NSSAI among pieces of S-NSSAI included in the subscription slice information, an indicator indicating the slice policy information may be included in the UDM 124. In addition, the UDM 124 may include PCF information (PCF ID or PCF set ID) managing the slice policy information associated with the S-NSSAI.

The above description referring to FIG. 2 is not limited to a specific part of the disclosure and may be applied to the entire description of the method and apparatus for managing a network slice described in the disclosure.

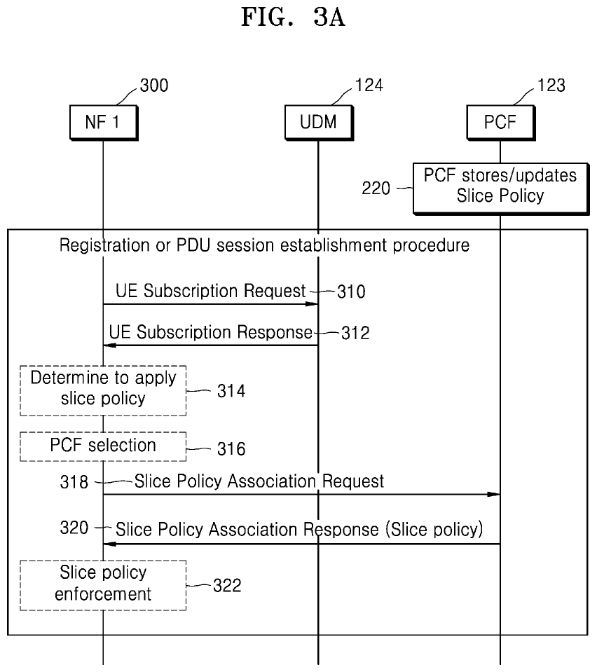

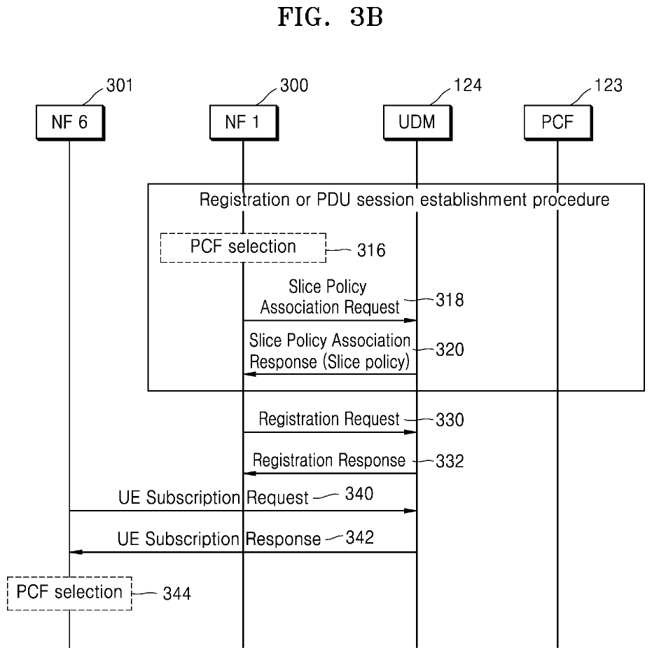

FIG. 3A is a flow diagram of a procedure by which the 5G system provides the managed slice policy information to an NF of the 5GC 120 according to an embodiment of the disclosure.

Referring to FIG. 3A, the PCF 123 according to an embodiment of the disclosure may store slice policy information associated with S-NSSAI in operation 220, via OAM and the procedure shown in FIG. 2.

The PCF 123 according to an embodiment of the disclosure may provide the slice policy information associated with the S-NSSAI to a first NF 300 configuring the 5GC 120. For example, the PCF 123 may provide the slice policy information associated with one or more pieces of S-NSSAI to the first NF 300 during a registration procedure. In this case, the first NF 300 may be the AMF 121. Alternatively, the PCF 123 may provide the slice policy information associated with the S-NSSAI to be used by a PDU session to the first NF 300 during a PDU session establishment procedure. In this case, the first NF 300 may be the SMF 122. In other words, the first NF 300 may denote one of NFs in a network.

The first NF 300 (for example, the AMF 121 or the SMF 122) according to an embodiment of the disclosure may request the UDM 124 for UE subscription information in operation 310, during the registration procedure or the PDU session establishment procedure. A UE subscription information request message (for example, a UE subscription request) may include a UE ID (for example, subscription permanent identifier (SUPI), 5G global unique temporary identifier (5G-GUTI), international mobile subscriber identity (IMSI), or the like). The UDM 124 may transmit the UE subscription information denoted by UE ID received via a UE subscription information response message (for example, a UE subscription response) to the first NE 300 (for example, the AMF 121 or the SMF 122), in operation 312. Here, a name of the message is not limited to that of FIG. 3A.

The first NF 300 (for example, the AMF 121 or the SMF 122) according to an embodiment of the disclosure may determine whether there is S-NSSAI with slice policy information from among network slices (pieces of S-NSSAI, subscribed S-NSSAI, and allowed NSSAI) to be provided to a UE, in operation 314, based on the UE subscription information received from the UDM 124. For example, when the UE subscription information includes an indicator indicating that there is the slice policy information associated with the S-NSSAI, the first NF 300 (for example, the AMF 121 or the SMF 122) may determine that the slice policy information for the S-NSSAI is to be applied.

The first NF 300 (for example, the AMF 121 or the SMF 122) according to an embodiment of the disclosure may select the PCF 123 supporting (serving) a slice policy of the S-NSSAI in operation 316. For example, the first NF 300 (for example, the AMF 121 or the SMF 122) may select the PCF 123 supporting a slice policy associated with the S-NSSAI, based on PCF information managing the slice policy information associated with the S-NSSAI included in the UE subscription information received in operation 312. Alternatively, the first NF 300 (for example, the AMF 121 or the SMF 122) may transmit an NF discovery request message for discovering the PCF supporting (serving) S-NSSAI policy information to the NRF 127, and select the PCF 123 supporting the slice policy associated with the S-NSSAI, based on the PCF information included in an NF discovery response message received from the NRF 127. Alternatively, the first NF 300 (for example, the AMF 121 or the SMF 122) may use slice policy association with the PCF 123 when the PCF 123 associated with the S-NSSAI is already selected during a previous registration procedure or PDU session establishment procedure for another UE.

The PCF 123 supporting the slice policy associated with the S-NSSAI may be the same as or different from a PCF managing a UE policy, an AM policy, or an SM policy.

In operation 318, the first NF 300 (for example, the AMF 121 or the SMF 122) according to an embodiment of the disclosure may transmit a slice policy association request message to the PCF 123 selected in operation 316. The slice policy association request message may include one or more pieces of S-NSSAI. In operation 320, the PCF 123 may transmit the requested slice policy information associated with the S-NSSAI to the first NF 300 (for example, the AMF 121 or the SMF 122). In addition, a message (for example, a slice policy association response message) transmitted by the PCF 123 to the first NF 300 in operation 320 may include slice quota information available to the first NF 300. For example, the slice quota information included in the message of operation 320 may include information indicating that a maximum number of registration UEs associated with S-NSSAI A is one million and a maximum number of registration UEs available to the first NF 300 is 300,000. When there are a plurality of NFs supporting the S-NSSAI A, a method below may be used to distribute a number of registration UEs to several NFs. Alternatively, for example, the slice quota information included in the message of operation 320 may include information indicating that a maximum number of sessions associated with the S-NSSAI A is three million and a maximum number of sessions available to the first NF 300 is 600,000. When there are a plurality of NFs supporting the S-NSSAI A, a method below may be used to distribute a number of sessions to several NFs.

The first NF 300 (for example, the AMF 121 or the SMF 122) and the PCF 123 perform the slice policy association establishment procedure associated with the S-NSSAI in operations 318 and 320, and exchange related information when an event associated to the slice policy information occurs in a following procedure.

The first NF 300 (for example, the AMF 121 or the SMF 122) according to an embodiment of the disclosure may enforce the slice policy associated with the S-NSSAI received from the PCF 123, in operation 322.

The first NF 300 (the AMF 121) according to an embodiment of the disclosure may determine an allowed slice (allowed NSSAI), based on the received slice policy information, in operation 322. For example, the first NF 300 (the AMF 121) may not provide an allowed slice to a UE greater than a maximum number of UEs or an allowed number of UEs.

For example, the first NF 300 (the SMF 122) according to an embodiment of the disclosure may determine whether to establish a PDU session, based on the received slice policy information, in operation 322. For example, the first NF 300 (the SMF 122) may not allow establishment of a session greater than a maximum number of sessions or an allowed number of sessions.

The first NF 300 according to an embodiment of the disclosure may store the PCF 123 associated with the S-NSSAI in the UDM 124, according to a procedure shown in FIG. 3B.

FIG. 3B is a flow diagram of a procedure of storing policy control function (PCF) information supporting a slice policy according to an embodiment of the disclosure.

Referring to FIGS. 3A and 3B, the first NF 300 (for example, the AMF 121 or the SMF 122) may select the PCF supporting (serving) the slice policy of the S-NSSAI in operation 316.

When there is no PCF supporting the slice policy of the S-NSSAI (for example, when there is no PCF information managing the slice policy information associated with the S-NSSAI in the UE subscription information received from the UDM 124 or when the PCF 123 associated with the S-NSSAI is not selected during the registration procedure or PDU session establishment procedure for another UE before the first NF 300), the first NF 300 may perform a procedure for selecting the PCF 123 managing the slice policy information associated with the S-NSSAI (for example, a procedure of transmitting the NF discovery request message for discovering the PCF supporting (serving) the S-NSSAI policy information to the NRF 127 and selecting the PCF 123 supporting the slice policy associated with the S-NSSAI, based on the PCF information included in the NF discovery response message received from the NRF 127).

In operation 318, the slice policy association request message may be transmitted to the PCF 123 selected in operation 316. The slice policy association request message may include one or more pieces of S-NSSAI. In operation 320, the PCF 123 may transmit the requested slice policy information associated with the S-NSSAI to the first NF 300 (for example, the AMF 121 or the SMF 122). Because this corresponds to the content of FIG. 3A, details thereof are omitted.

In operation 330, the first NF 300 may register, provide, or transmit the PCF information selected in operation 316 in or to the UDM 124. For example, a registration request message transmitted by the first NF 300 to the UDM 124 may include the S-NSSAI and the PCF information (for example, PCF ID) selected in association with the S-NSSAI. Here, a name of the message is not limited to that of FIG. 3B.

The UDM 124 may store information (for example, the S-NSSAI and the PCF information selected in association with the S-NSSAI) received from the first NF 300. For example, the UDM 124 may store the S-NSSAI and the PCF information selected in association with the S-NSSAI as subscription information.

In operation 332, the UDM 124 may transmit a registration response message to the first NF 300. Here, a name of the message is not limited to that of FIG. 3B.

Operations 340 through 344 may correspond to operations 310 through 316 of FIG. 3A.

More particularly, a sixth NF 301 (for example, the AMF 121 or the SMF 122) may request the UDM 124 for the UE subscription information in operation 340 (corresponds to operation 310 of FIG. 3A).

In operation 342, the UDM 124 may transmit the UE subscription information denoted by UE ID received via the UE subscription information response message (for example, the UE subscription response) to the sixth NE 301 (for example, the AMF 121 or the SMF 122) (corresponds to operation 312 of FIG. 3A). The UDM 124 may add the PCF information associated with the S-NSSAI, which is stored according to the information received in operation 330, to the UE subscription information.

The sixth NF 301 (for example, the AMF 121 or the SMF 122) may select the PCF 123 supporting (serving) the slice policy of the S-NSSAI in operation 344 (corresponds to operation 316 of FIG. 3A). For example, the sixth NF 301 (for example, the AMF 121 or the SMF 122) may select the PCF 123 supporting the slice policy associated with the S-NSSAI, based on the PCF information managing the slice policy information associated with the S-NSSAI included in the UE subscription information received in operation 342.

The UDM 124 according to an embodiment of the disclosure may store the PCF information associated with the S-NSSAI, according to the procedure shown in FIG. 3B. In addition, the UDM 124 may provide the stored PCF information associated with the S-NSSAI to the first NF 300 or the sixth NF 301 (for example, operation 312 of FIG. 3A or operation 342 of FIG. 3B).

The above description referring to FIGS. 3A and 3B is not limited to a specific part of the disclosure and may be applied to the entire description of the method and apparatus for managing a network slice described in the disclosure.

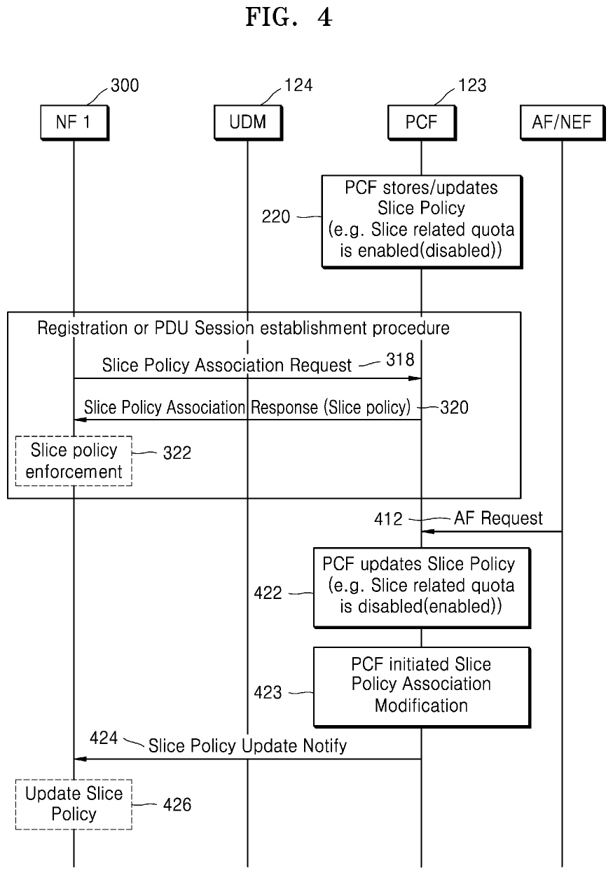

FIG. 4 is a flow diagram of a procedure by which the 5G system updates the managed slice policy information according to an embodiment of the disclosure.

Referring to FIG. 4, the PCF 123 according to an embodiment of the disclosure may store the slice policy information associated with the S-NSSAI in operation 220, via OAM and the procedure shown in FIG. 2. In operation 220, information about a slice-related quota may be set to be applied or not applied. For example, a value of the indication whether to enable/disable the quota on the maximum number of UEs, the indication whether to enable/disable the quota on the maximum number of sessions, or the indication whether to enable/disable the quota on the maximum data rates included in the slice policy information stored in the PCF 123 may be set to enable or disable. In addition, the first NF 300 according to an embodiment of the disclosure may obtain, from the PCF 123, the slice policy information associated with the S-NSSAI via the procedure of FIG. 3A, and corresponds store and use (apply or enforce) the slice policy information in operation 322.

An AF according to an embodiment of the disclosure may transmit an AF request message to the PCF 123 in operation 412 to update the slice policy information stored in the PCF 123. For example, the AF may add, to the AF request message, at least one value from among AF ID indicating the AF, S-NSSAI indicating a slice, the maximum number of UEs associated with the S-NSSAI, the maximum number of sessions, the indication whether to enable/disable the quota on the maximum number of UEs, the indication whether to enable/disable the quota on the maximum number of sessions, the indication whether to enable/disable the quota on the maximum data rates, and the usage monitoring control condition. The AF may transmit the AF request message to the PCF 123 directly or through the NEF 129 of FIG. 1.

According to an embodiment of the disclosure, the PCF 123 may update the slice policy information stored in the PCF 123, based on the received AF request message, in operation 422. The PCF 123 may compare the slice policy information received in operation 412 with slice policy information matching the S-NSSAI included in the AF request message received in operation 412 from among the slice policy information stored in operation 220. When the slice policy information stored in operation 220 and the slice policy information received in operation 412 are different from each other, the PCF 123 may update the slice policy information to the slice policy information received in operation 412 (i.e., latest slice policy information). For example, the indication whether to enable/disable the quota on the maximum number of UEs associated with the S-NSSAI stored in the PCF 123 in operation 220 is set to enable but the indication whether to enable/disable the quota on the maximum number of UEs in the slice policy information received in operation 412 may be set to disable. In this case, the PCF 123 may change the indication to disable as the latest information received in operation 142.

According to an embodiment of the disclosure, the PCF 123 may determine an NF that is applying the slice policy information, in operation 423, and determine an NF that established the slice policy association in operations 318 through 320 of FIG. 3A. When the slice policy information provided to the first NF 300 in operation 320 and the slice policy information updated in operation 422 are different from each other, the PCF 123 may provide the updated slice policy information to the NF that established the slice policy association or the NF that is applying the slice policy information, in operation 424.

In operation 426, the first NF 300 may update the stored or being applied slice policy information based on the received updated slice policy information, and apply the updated slice policy information.

For example, when the indication whether to enable/disable the quota on the maximum number of UEs associated with the S-NSSAI A stored in the PCF 123 in operation 220 is set to enable, the PCF 123 may set the indication whether to enable/disable the quota on the maximum number of UEs to enable and transmit the indication whether to enable/disable the quota on the maximum number of UEs to the first NF 300 in operation 320. In this case, the first NF 300 may be the AMF 121 of FIG. 1. The first NF 300 (for example, the AMF 121) may apply UE number control during UE registration procedure, based on the indication received from the PCF 123. Then, when the indication whether to enable/disable the quota on the maximum number of UEs associated with the S-NSSAI A stored in the PCF 123 is changed to disable in operation 422, the PCF 123 may set the indication whether to enable/disable the quota on the maximum number of UEs to disable and transmit the indication whether to enable/disable the quota on the maximum number of UEs to the first NF 300 (for example, the AMF 121) in operation 424. The first NF 300 may not apply the UE number control during the UE registration procedure, based on the indication received from the PCF 123.

For example, when the indication whether to enable/disable the quota on the maximum number of sessions associated with the S-NSSAI A stored in the PCF 123 in operation 220 is set to enable, the PCF 123 may set the indication whether to enable/disable the quota on the maximum number of sessions to enable and transmit the indication whether to enable/disable the quota on the maximum number of sessions to the first NF 300 in operation 320. In this case, the first NF 300 may be the SMF 122 of FIG. 1. The first NF 300 (for example, the SMF 122) may apply session number control during the session establishment procedure, based on the indication received from the PCF 123. Then, when the indication whether to enable/disable the quota on the maximum number of sessions associated with the S-NSSAI A stored in the PCF 123 is changed to disable in operation 422, the PCF 123 may set the indication whether to enable/disable the quota on the maximum number of sessions to disable and transmit the indication whether to enable/disable the quota on the maximum number of sessions to the first NF 300 (for example, the SMF 122) in operation 424. The first NF 300 may not apply the session number control during the session establishment procedure, based on the indication received from the PCF 123.

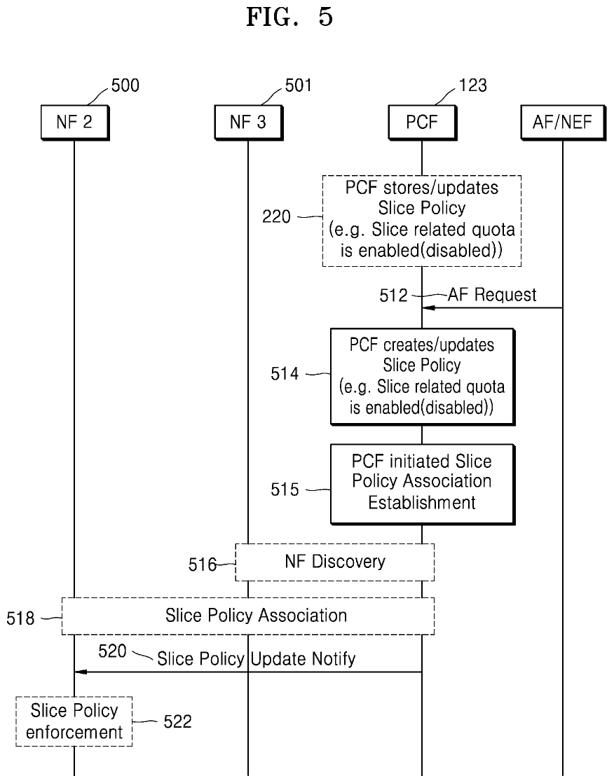

FIG. 5 is a flow diagram of a procedure by which the 5G system updates the managed slice policy information according to an embodiment of the disclosure.

Referring to FIG. 5, the PCF 123 according to an embodiment of the disclosure may store the slice policy information associated with the S-NSSAI in operation 220, via OAM and the procedure shown in FIG. 2. In operation 220, information about a slice-related quota may be set to be applied or not applied. For example, the value of the indication whether to enable/disable the quota on the maximum number of UEs, the indication whether to enable/disable the quota on the maximum number of sessions, or the indication whether to enable/disable the quota on the maximum data rates included in the slice policy information stored in the PCF 123 may be set to enable or disable.

An AF according to an embodiment of the disclosure may transmit an AF request message to the PCF 123 in operation 512 to update the slice policy information stored in the PCF 123. In addition, an AF according to an embodiment of the disclosure may generate new slice policy information for the S-NSSAI and transmit the AF request message to the PCF 123 in operation 512. The AF request message of operation 512 may be configured in the same manner as the AF request message of operation 412 of FIG. 4. The AF may transmit the AF request message to the PCF 123 directly or through the NEF 129 of FIG. 1.

The PCF 123 according to an embodiment of the disclosure may update the slice policy information based on the received AF request message, in operation 514. The slice policy information may be updated in operation 514 in the same manner as operation 422 of FIG. 4. Alternatively, when there is no S-NSSAI matching the slice policy information received in operation 514 from among the slice policy information stored in operation 220, the PCF 123 may newly generate and store slice policy information for the received S-NSSAI, in operation 514.

In operation 515, the PCF 123 according to an embodiment of the disclosure may determine whether slice policy association establishment is required for the slice policy information stored/updated in operation 514. For example, when the slice policy information for the S-NSSAI is newly generated in operation 514, the PCF 123 may determine that the slice policy association establishment is required. Alternatively, for example, when the indication whether to enable/disable the quota on the maximum number of UEs associated with the S-NSSAI stored in the PCF 123 in operation 220 is set to disable, but the indication for the slice policy information received in operation 512 is set to enable, the PCF 123 may determine that the slice policy association establishment for the S-NSSAI is required.

In operation 516, the PCF 123 according to an embodiment of the disclosure may determine an NF to which the slice policy information is to be applied. For example, the PCF 123 may determine the NF to which the slice policy information is to be applied via the NF discovery procedure. In addition, the PCF 123 may provide the slice policy information to the NF in operations 518 and 520. A method by which the PCF 123 discovers the NF in operation 516 may use any one of various methods below.

For example, the PCF 123 may transmit, to a third NF 501, a message including the slice policy information of operations 518 and 520. In this case, the third NF 501 may be the SCP 128 of FIG. 1. The third NF 501 (for example, the SCP 128) may transmit the message of operations 518 and 520 to a second NF 500 that is an NF supporting (serving) the S-NSSAI, based on the S-NSSAI included in the received message.

Alternatively, the PCF 123 may determine the NF based on information obtained from the third NF 501. In this case, the third NF 501 may be the UDM 124 of FIG. 1. The third NF 501 (for example, the UDM 124) may store information about the NF (for example, the second NF 500, serving AMF, or serving SMF) supporting (serving) the S-NSSAI and provide the information to the PCF 123. To obtain the information about the NF from the third NF 501 (the UDM 124), the PCF 123 may obtain the information from the third NF 501 (the UDM 124) in operation 516 or use information obtained from the third NF 501 (the UDM 124) and stored in the PCF 123 before operation 516.

Alternatively, the PCF 123 may determine the NF by transmitting the NF discovery request message to the third NF 501. In this case, the third NF 501 may be the NRF 127 of FIG. 1. The NF discovery request message transmitted by the PCF 123 to the third NF 501 (for example, the NRF 127) may include the S-NSSAI and information indicating that the NF supporting (serving) the S-NSSAI is searched for (and information for NF search). The third NF 501 (for example, the NRF 127) may find the NF supporting the S-NSSAI, based on registered NF profile information, and then add the information about the NF (for example, the second NF 500) to the NF discovery response message transmitted to the PCF 123. The PCF 123 may transmit the message of operations 518 and 520 to the second NF 500, i.e., the NF supporting (serving) the S-NSSAI, based on the information about the NF received from the third NF 501 (for example, the NRF 127). For example, the PCF 123 may perform the slice policy association procedure with the second NF 500 and transmit a slice policy update notification to the second NF 500.

The PCF 123 according to an embodiment of the disclosure may provide the updated slice policy information to the second NF 500 in operation 520 by using any one of various methods described above. In operation 522, the second NF 500 may apply the received updated slice policy information.

For example, when the indication whether to enable/disable the quota on the maximum number of UEs associated with the S-NSSAI A stored in the PCF 123 in operation 220 is set to disable, the PCF 123 may not apply maximum UE number control of a network slice indicated by the S-NSSAI A. Then, when the indication whether to enable/disable the quota on the maximum number of UEs associated with the S-NSSAI A stored in the PCF 123 is changed to enable in operation 514, the PCF 123 may set the indication whether to enable/disable the quota on the maximum number of UEs to enable and transmit the indication and the slice policy information associated with the S-NSSAI A to the second NF 500 in operations 518 and 520. In this case, the second NF 500 may be the AMF 121. The second NF 500 (the AMF 121) may apply the UE number control during the UE registration procedure, based on the indication received from the PCF 123.

For example, when the indication whether to enable/disable the quota on the maximum number of sessions associated with the S-NSSAI A stored in the PCF 123 in operation 220 is set to disable, the PCF 123 may not apply maximum session number control of the network slice indicated by the S-NSSAI A. Then, when the indication whether to enable/disable the quota on the maximum number of sessions associated with the S-NSSAI A stored in the PCF 123 is changed to enable in operation 514, the PCF 123 may set the indication whether to enable/disable the quota on the maximum number of sessions to enable and transmit the indication and the slice policy information associated with the S-NSSAI A to the second NF 500 in operations 518 and 520. In this case, the second NF 500 may be the SMF 122. The second NF 500 (the SMF 122) may apply the session number control during the session establishment procedure, based on the indication received from the PCF 123.

According to an embodiment of the disclosure, the 5G system may transmit a notification message to an AF when the slice policy information is changed.

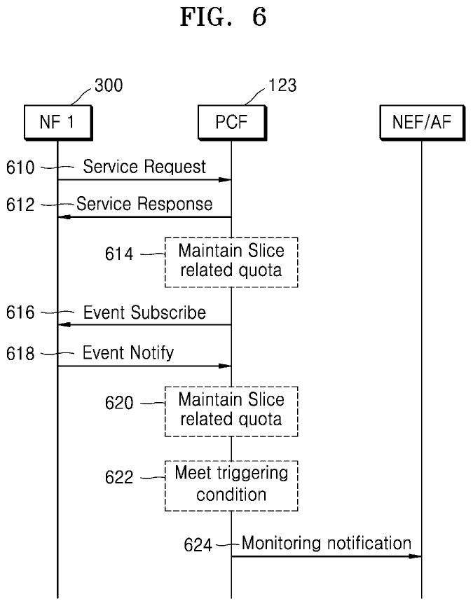

FIG. 6 is a flow diagram of a procedure by which the 5G system transmits a monitoring report of the managed slice policy information to the AF according to an embodiment of the disclosure.

Referring to FIG. 6, the PCF 123 according to an embodiment of the disclosure may monitor usage of the S-NSSAI by communicating with the first NF 300 supporting (serving) the S-NSSAI associated with the slice policy information.

For example, a service request message transmitted by the first NF 300 to the PCF 123 in operation 610 may include information about a current number of registration UEs or a current number of established sessions supported by the first NF 300 in association with the S-NSSAI. A message (the service request message) of operation 610 may be a message (the slice policy association request message) of operation 318 of FIG. 3A. In operation 612, the PCF 123 may transmit a service response message to the NF 300 and may manage the slice information associated with the S-NSSAI in operation 614, based on information received in operation 610. As described above, the description described with reference to FIGS. 1 to 3B may be applied throughout the disclosure, and thus may also be applied to description referring to FIG. 6. For example, the operation 610 may be performed after operations 210 to 220 of FIG. 2 (operations 212 to 216 are optional) and operations 310 to 316 of FIG. 3 (operations 314 and 316 are optional). For example, before operation 610, as in operations 212 to 218 of FIG. 2, the AF 140 or 150 may transmit the AF request message to the PCF 123 through the NEF 129 or directly to the PCF 123, and the AF request message may include slice policy information including slice related quota information.

The PCF 123 may transmit an event subscription message (for example, Event Subscribe) related to the information about the current number of registration UEs or the current number of established sessions supported in association with the S-NSSAI to the first NF 300, in operation 616. A message of operation 616 may be included in a message (for example, the slice policy association response message) of operation 320 of FIG. 3A. The first NF 300 may transmit an event notification message to the PCF 123 in operation 618, when the information about the current number of registration UEs or the current number of established sessions supported in association with the S-NSSAI is changed. The event notification message may include the information about the current number of registration UEs or the current number of established sessions supported by the first NF 300 in association with the S-NSSAI. The PCF 123 may manage the slice information associated with the S-NSSAI in operation 620, based on information received in operation 618.

For example, when the maximum number of UEs associated with the S-NSSAI A (for example, a network slice A) is one million and information included in the message received from the first NF 300 in operation 610 or 618 indicates that 800,000 UEs are currently registered in the first NF 300, the PCF 123 may store 800,000 for the number of registration UEs associated with the S-NSSAI A in operation 614 or 620. When one or more NFs support the S-NSSAI A, the PCF 123 may store a sum of numbers of registration UEs obtained from all NFs supporting the S-NSSAI A as the number of registration UEs associated with the S-NSSAI A. The PCF 123 may store, in the UDR 130 of FIG. 1, the information about the number of registration UEs associated with the S-NSSAI A that is slice information associated with the S-NSSAI.

For example, when the maximum number of sessions associated with the S-NSSAI A is three million and the information included in the message received from the first NF 300 in operation 610 or 618 indicates that 2.3 million sessions are currently established in the first NF 300, the PCF 123 may store 2.3 million as the number of sessions associated with the S-NSSAI A in operation 614 or 620. When one or more NFs support the S-NSSAI A, the PCF 123 may store a sum of numbers of sessions obtained from all NFs supporting the S-NSSAI A as the number of sessions associated with the S-NSSAI A. The PCF 123 may store, in the UDR 130, the information about the number of sessions associated with the S-NSSAI A.

The PCF 123 according to an embodiment of the disclosure may determine whether the usage monitoring control condition is satisfied in operation 622, based on the slice policy information and the current number of registration UEs stored in the PCF 123 or UDR 130. For example, when the maximum number of registration UEs associated with the S-NSSAI A is one million and the usage monitoring control condition is 800,000, the PCF 123 may determine that a triggering condition is satisfied in operation 622 when the current number of registration UEs satisfies the usage monitoring control condition (i.e., when the current number of registration UEs is equal to or greater than 800,000) and/or when the current number of registration UEs satisfies the maximum number of registration UEs (i.e., when the current number of registration UEs is equal to or greater than one million), based on the current number of registration UEs associated with the S-NSSAI A managed in operation 614 or 620, and transmit a monitoring notification message to the AF in operation 624. The monitoring notification message of operation 624 may include at least one of the S-NSSAI, event ID, or slice usage information (for example, the current number of registration UEs, the current number of established sessions, or the like). The AF may identify the number of registration UEs associated with the S-NSSAI A, based on the received information.

The PCF 123 according to an embodiment of the disclosure may determine whether the usage monitoring control condition is satisfied in operation 622, based on the slice policy information and the current number of sessions stored in the PCF 123 or UDR 130. For example, when the maximum number of sessions associated with the S-NSSAI A is three million and the usage monitoring control condition is 2.5 million, the PCF 123 may determine that the triggering condition is satisfied in operation 622 when the current number of sessions satisfies the usage monitoring control condition (i.e., when the current number of sessions is equal to or greater than 2.5 million) and/or when the current number of sessions satisfies the maximum number of sessions (i.e., when the current number of sessions is equal to or greater than three million), based on the current number of sessions associated with the S-NSSAI A managed in operation 614 or 620, and transmit the monitoring notification message to the AF in operation 624. The monitoring notification message of operation 624 may include at least one of the S-NSSAI, event ID, or slice usage information (for example, the current number of registration UEs, the current number of established sessions, or the like). The AF may identify the number of sessions associated with the S-NSSAI A, based on the received information.

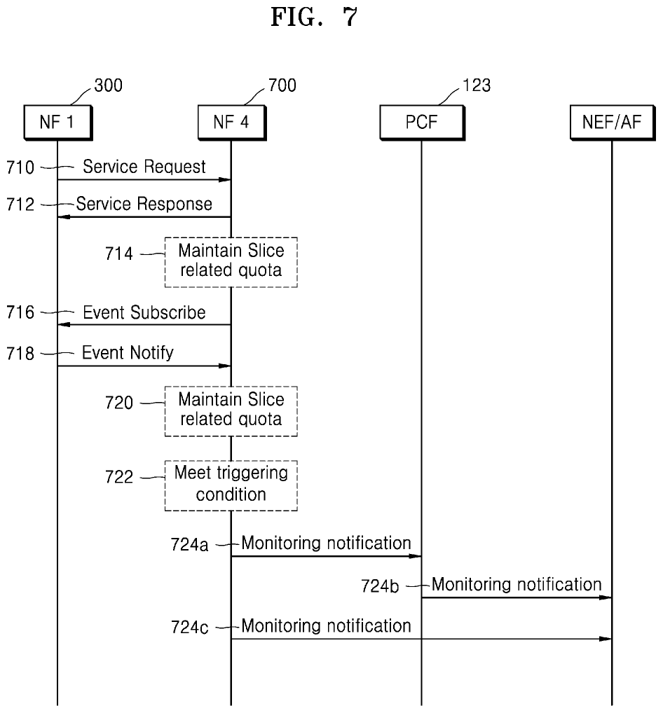

FIG. 7 is a flow diagram of a procedure by which the 5G system transmits the monitoring report of the managed slice policy information to the AF according to an embodiment of the disclosure.

Referring to FIG. 7, a fourth NF 700 (for example, the NSSF 126, the NRF 127, or the SCP 128) according to an embodiment of the disclosure may monitor the usage of the S-NSSAI by communicating with the first NF 300 supporting (serving) the S-NSSAI associated with the slice policy information.

For example, the service request message transmitted by the first NF 300 to the fourth NF 700 in operation 710 may include the information about the current number of registration UEs or the current number of established sessions supported by the first NF 300 in association with the S-NSSAI. In operation 712, the fourth NF 700 may transmit a service response message to the NF 300 and may manage the slice information associated with the S-NSSAI in operation 714, based on information received in operation 710.

According to an embodiment of the disclosure, the fourth NF 700 may transmit, to the first NF 300, the event subscription message related to the current number of registration UEs or the current number of established sessions supported in association of the S-NSSAI, in operation 716. The first NF 300 may transmit the event notification message to the fourth NF 700 in operation 718, when the information about the current number of registration UEs or the current number of established sessions supported in association with the S-NSSAI is changed. The event notification message may include the information about the current number of registration UEs or the current number of established sessions supported by the first NF 300 in association with the S-NSSAI. The fourth NF 700 may manage the slice information associated with the S-NSSAI in operation 720, based on information received in operation 718.

For example, when the maximum number of UEs associated with the S-NSSAI A is one million and the information included in the message received from the first NF 300 in operation 710 or 718 indicates that 800,000 million UEs are currently registered in the first NF 300, the fourth NF 700 may store 800,000 as the number of registration UEs associated with the S-NSSAI A in operation 714 or 720. When one or more NFs support the S-NSSAI A, the fourth NF 700 may store a sum of numbers of registration UEs obtained from all NFs supporting the S-NSSAI A as the number of registration UEs associated with the S-NSSAI A. The fourth NF 700 may store, in the UDR 130, the information about the number of registration UEs associated with the S-NSSAI A.

For example, when the maximum number of sessions associated with the S-NSSAI A is three million and the information included in the message received from the first NF 300 in operation 710 or 718 indicates that 2.3 million sessions are currently established in the first NF 300, the fourth NF 700 may store 2.3 million as the number of sessions associated with the S-NSSAI A in operation 714 or 720. When one or more NFs support the S-NSSAI A, the fourth NF 700 may store a sum of numbers of sessions obtained from all NFs supporting the S-NSSAI A as the number of sessions associated with the S-NSSAI A. The fourth NF 700 may store, in the UDR 130, the information about the number of sessions associated with the S-NSSAI A.

The fourth NF 700 according to an embodiment of the disclosure may determine whether the usage monitoring control condition is satisfied in operation 722, based on the slice policy information and the current number of registration UEs or sessions stored in the fourth NF 700 or UDR 130. A method by which the fourth NF 700 determines whether the usage monitoring control condition is satisfied may be the same as that performed by the PCF 123 described in operation 622 of FIG. 6.

The fourth NF 700 according to an embodiment of the disclosure may determine that the triggering condition is satisfied in operation 722 and transmit the monitoring notification message to the AF in operation 724a to the PCF 123. The monitoring notification message of operation 724 may include at least one of the S-NSSAI, event ID, or slice usage information (for example, the current number of registration UEs, the current number of established sessions, or the like). The message of operation 724a may be transmitted to the AF through the PCF 123 in operation 724b, through the NEF, or directly in operation 724c. The AF may identify the number of registration UEs or sessions associated with the S-NSSAI A, based on the received information.

In the 5G system according to an embodiment of the disclosure, two or more NFs may support the S-NSSAI.

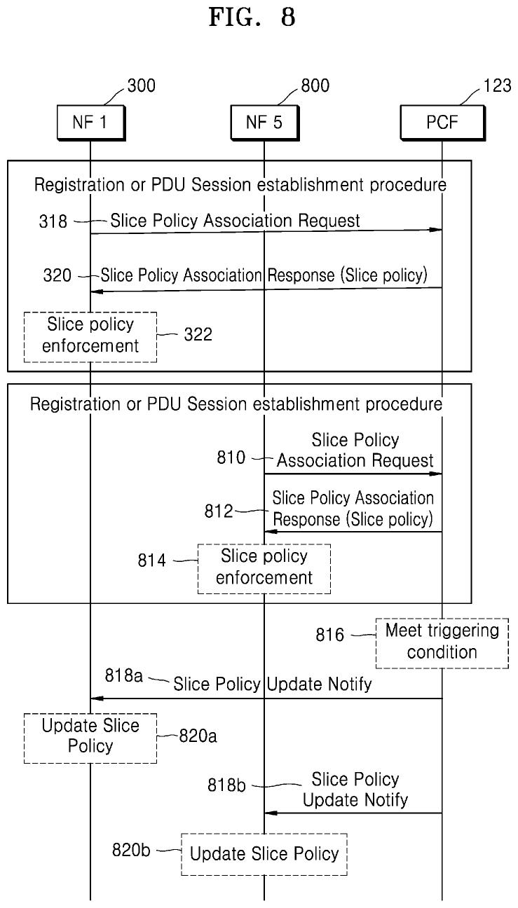

FIG. 8 is a flow diagram of a procedure by which the 5G system applies the managed slice policy to the plurality of NFs according to an embodiment of the disclosure.

Referring to FIG. 8, the first NF 300 and a fifth NF 800 according to an embodiment of the disclosure may be NFs supporting (serving) the same S-NSSAI. For example, the first NF 300 may apply the slice policy information associated with the S-NSSAI in operation 322 by performing operations 318 and 320. In addition, the fifth NF 800 may apply the slice policy information associated with the S-NSSAI in operation 814 by performing operations 810 and 812.

The PCF 123 according to an embodiment of the disclosure may obtain the information about the number of registration UEs and the number of sessions supported by an NF from the first NF 300 and the fifth NF 800 via the procedure shown in FIG. 6. In an embodiment, the PCF 123 according to an embodiment of the disclosure may obtain the information about the number of registration UEs and the number of sessions supported by an NF from the first NF 300 and the fifth NF 800 via the procedure shown in FIG. 7.

The PCF 123 according to an embodiment of the disclosure may determine whether a notification triggering condition is satisfied in operation 816, based on the information received from the first NF 300 and the fifth NF 800. For example, when the maximum number of registration UEs associated with the S-NSSAI A is one million, the current number of registration UEs allowed to use the S-NSSAI A supported by the first NF 300 is 490,000, and the current number of registration UEs allowed to use the S-NSSAI A supported by the fifth NF 800 is 510,000, the PCF 123 may determine that the maximum number of registration UEs associated with the S-NSSAI A has exceeded. Accordingly, the PCF 123 may transmit the notification message to the first NF 300 and/or the fifth NF 800 in operation 818a or 818b. The notification message may include information indicating that the maximum number of registration UEs associated with the S-NSSAI A has exceeded. For example, the notification message may include at least one of S-NSSAI and the current number of registration UEs. Upon receiving the notification message, the first NF 300 and/or the fifth NF 800 may update the slice policy information associated with the S-NSSAI A in operation 820a or 820b, based on the received information. For example, the first NF 300 and/or the fifth NF 800 may determine that the maximum number of registration UEs associated with the S-NSSAI A has exceeded and thereafter reject an S-NSSAI A request (requested NSSAI).

The PCF 123 according to an embodiment of the disclosure may determine whether a notification triggering condition is satisfied in operation 816, based on the information received from the first NF 300 and the fifth NF 800. For example, when the maximum number of sessions associated with the S-NSSAI A is three million, the number of sessions using the S-NSSAI A supported by the first NF 300 is 1.49 million, and the number of sessions using the S-NSSAI A supported by the fifth NF 800 is 1.51 million, the PCF 123 may determine that the maximum number of sessions associated with the S-NSSAI A has exceeded. Accordingly, the PCF 123 may transmit the notification message to the first NF 300 and/or the fifth NF 800 in operation 818a or 818b. The notification message may include information indicating that the maximum number of sessions associated with the S-NSSAI A has exceeded. For example, the notification message may include at least one of S-NSSAI and the current number of established sessions. Upon receiving the notification message, the first NF 300 and/or the fifth NF 800 may update the slice policy information associated with the S-NSSAI A in operation 820a or 820b, based on the received information. For example, the first NF 300 and/or the fifth NF 800 may determine that the maximum number of sessions associated with the S-NSSAI A has exceeded and thereafter reject an S-NSSAI A request (PDU session establishment request or PDN connection setup request).

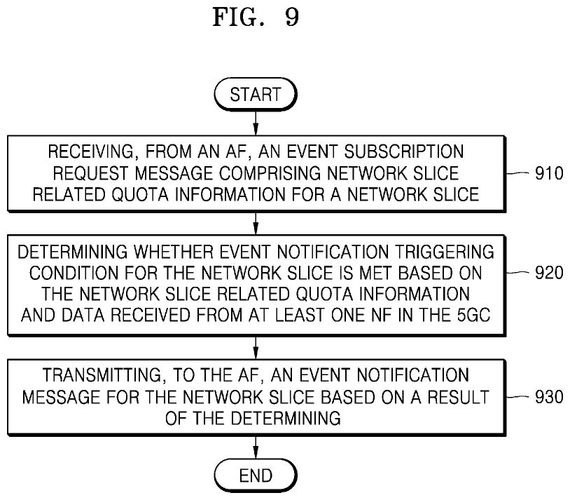

FIG. 9 is a flow diagram for describing a method by which a network function (NF) in 5GC manages a network slice in an embodiment of the disclosure.

Referring to FIG. 9, in operation 910, the NF receives, from an application function (AF), an event subscription request message comprising network slice related quota information for a network slice. In an embodiment of the disclosure, the NF is a policy control function (PCF).

In an embodiment of the disclosure, the network slice related quota information for the network slice may comprise at least one of a maximum number of user equipment (UEs) to be registered for the network slice or a maximum number of protocol data unit (PDU) sessions to be established for the network slice.

In an embodiment of the disclosure, the NF may store the network slice related quota information.

In an embodiment of the disclosure, the NF may update quota of the network slice based on the network slice related quota information.

In operation 920, the NF may determine whether an event notification triggering condition for the network slice is met based on the network slice related quota information and data received from at least one NF in the 5GC.

In an embodiment of the disclosure, the NF may monitor a current number of UEs being registered for the network slice. The NF may determine whether the event notification triggering condition for the network slice is met based on the network slice related quota information and a result of the monitoring.

In an embodiment of the disclosure, the NF may update a current number of PDU sessions successfully established for the network slice based on the maximum number of PDU sessions to be established for the network slice.

In an embodiment of the disclosure, the event notification triggering condition may comprise at least one of a first condition that a current number of UEs being registered for the network slice is equal to or greater than the maximum number of UEs to be registered for the network slice or a second condition that a current number of PDU sessions successfully established for the network slice is equal to or greater than the maximum number of protocol data unit (PDU) sessions to be established for the network slice.

In an embodiment of the disclosure, the network slice related quota information for the network slice may further comprise a maximum data rate for the network slice.

In an embodiment of the disclosure, the data received from at least one NF in the 5GC may comprise at least one of each of a current number of UEs being registered for the network slice and supported by each of the at least one NF, respectively, or each of a current number of PDU sessions successfully established for the network slice and supported by each of the at least one NF, respectively.

In operation 930, the NF transmits, to the AF, an event notification message for the network slice based on a result of the determining.

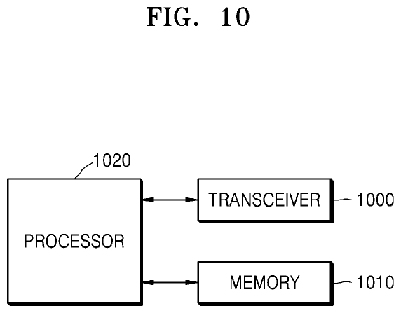

FIG. 10 is a block diagram of a configuration of a UE according to an embodiment of the disclosure.

The UE according to an embodiment of the disclosure may include a processor 1020 controlling overall operations of the UE, a transceiver 1000 including a transmitter and a receiver, and a memory 1010. However, the UE is not limited thereto and may include more or less components than those shown in FIG. 10.

Referring to FIG. 10, the transceiver 1000 may transmit or receive a signal to or from an NE or another UE. The signal transmitted or received to or from the NE may include control information and data. In addition, the transceiver 1000 may receive and output, to the processor 1020, a signal through a wireless channel, and transmit a signal output from the processor 1020 through the wireless channel.

According to an embodiment of the disclosure, the processor 1020 may control the UE to perform any one of operations according to the embodiments of the disclosure described above. The processor 1020, the memory 1010, and the transceiver 1000 are not necessarily implemented in separate modules, and may be obviously implemented in one component in a form of a single chip. In addition, the processor 1020 and the transceiver 1000 may be electrically connected to each other. In addition, the processor 1020 may be an application processor (AP), a communication processor (CP), a circuit, an application-specific circuit, or at least one processor.

According to an embodiment of the disclosure, the memory 1010 may store a basic program, an application program, and data, such as configuration information, for operations of the UE. More particularly, the memory 1010 may provide the stored data upon request by the processor 1020. The memory 1010 may be a storage medium, such as read-only memory (ROM), random-access memory (RAM), a hard disk, a compact disc-ROM (CD-ROM), and a digital versatile disc (DVD), or a combination of storage media. In addition, there may be a plurality of the memories 1010. The processor 1020 may perform the above-described embodiments of the disclosure based on the program for performing the above-described embodiments of the disclosure stored in the memory 1010.

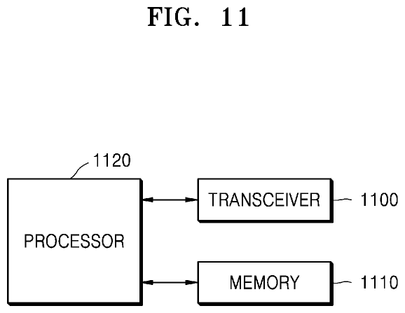

FIG. 11 is a block diagram of a configuration of an NE according to an embodiment of the disclosure.

Referring to FIG. 11, the NE according to an embodiment of the disclosure may include a processor 1120 controlling overall operations of the NE, a transceiver 1100 including a transmitter and a receiver, and a memory 1110. However, the NE is not limited thereto and may include more or less components than those shown in FIG. 11.

According to an embodiment of the disclosure, the transceiver 1100 may transmit or receive a signal to or from at least one of another NE or UE. The signal transmitted or received to or from the other NE or UE may include control information and data.

According to an embodiment of the disclosure, the processor 1120 may control the NE to perform any one of operations according to the embodiments of the disclosure described above. The processor 1120, the memory 1110, and the transceiver 1100 are not necessarily implemented in separate modules, and may be obviously implemented in one component in a form of a single chip. In addition, the processor 1120 and the transceiver 1100 may be electrically connected to each other. In addition, the processor 1120 may be an AP, a CP, a circuit, an application-specific circuit, or at least one processor.

According to an embodiment of the disclosure, the memory 1110 may store a basic program, an application program, and data, such as configuration information, for operations of the NE. More particularly, the memory 1110 may provide the stored data upon request by the processor 1120. The memory 1110 may be a storage medium, such as ROM, RAM, a hard disk, a CD-ROM, and a DVD, or a combination of storage media. In addition, there may be a plurality of the memories 1110. The processor 1120 may perform the above-described embodiments of the disclosure based on the program for performing the above-described embodiments of the disclosure stored in the memory 1110.

It should be noted that the above-described configuration diagram, the diagram of a control/data signal transmission method, and the diagram of an operation procedure are not intended to limit the scope of the disclosure. For example, all configurations, entities, or operations described in the embodiments of the disclosure should not be interpreted as being essential components for the implementation of the disclosure, and the embodiments of the disclosure may be implemented within the scope that does not impair the essence of the disclosure even by including only some components. In addition, the embodiments of the disclosure may be combined with each other when required. For example, some of methods proposed in the disclosure may be combined with each other to operate a network entity and a UE.

Operations of a base station or UE described above may be registrations implemented by including a memory device storing corresponding program code in an arbitrary configuration in the base station or UE. In other words, a controller of the base station or UE may execute the above-described operations by reading and executing program code stored in the memory device by a processor or a central processing unit (CPU).

Various components and modules of an entity, a base station, or a UE described herein may operate by using a hardware circuit, for example, a combination of at least one of a complementary metal oxide semiconductor-based logic circuit, firmware, software firmware, hardware firmware, or software inserted into a machine-readable medium. For example, various electrical structures and methods may be implemented by using transistors, logic gates, and electrical circuits, such as an application-specific integrated circuits.

When the electrical structures and methods are implemented in software, a computer-readable recording medium having one or more programs (software modules) recorded thereon may be provided. The one or more programs recorded on the computer-readable recording medium are configured to be executable by one or more processors in a device. The one or more programs include instructions to execute the methods according to the embodiments of the disclosure described in the claims or the detailed description.

The programs (e.g., software modules or software) may be stored in random access memory (RAM), non-volatile memory including flash memory, read-only memory (ROM), electrically erasable programmable read-only memory (EEPROM), a magnetic disc storage device, a CD-ROM, a DVD, another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network, such as the Internet, an intranet, a local area network (LAN), a wireless LAN (WLAN), or a storage area network (SAN), or a combination thereof. The storage device may be connected through an external port to an apparatus according the embodiments of the disclosure. Another storage device on the communication network may also be connected to the apparatus performing the embodiments of the disclosure.

The embodiments of the disclosure provide an apparatus and method for effectively providing a service in a wireless communication system.

In the afore-described embodiments of the disclosure, elements included in the disclosure are expressed in a singular or plural form according to the embodiments of the disclosure. However, the singular or plural form is appropriately selected for convenience of explanation and the disclosure is not limited thereto. As such, an element expressed in a plural form may also be configured as a single element, and an element expressed in a singular form may also be configured as plural elements.

Meanwhile, specific embodiments of the disclosure have been described in the detailed description of the disclosure, but various modifications may be possible without departing from the scope of the disclosure. Therefore, the scope of the disclosure should not be limited to the embodiments of the disclosure described above, but should be determined not only by the scope of the following claims, but also by the equivalents of the claims. In other words, it will be apparent to one of ordinary skill in the art that other modifications based on the technical ideas of the disclosure are feasible. In addition, the embodiments of the disclosure may be combined with each other as required. For example, a base station and a UE may operate with some of the embodiments of the disclosure combined together. In addition, the embodiments of the disclosure are proposed based on a 5G or NR system, but other modifications based on technical ideas of the embodiments of the disclosure may be implemented on other systems, such as an LTE, LTE-A, LTE-A-Pro systems.

Meanwhile, specific embodiments of the disclosure have been described in the detailed description of the disclosure, but various modifications may be possible without departing from the scope of the disclosure. Therefore, the scope of the disclosure should not be limited to the embodiments of the disclosure described above, but should be determined not only by the scope of the following claims, but also by the equivalents of the claims.

Hereinafter, operation principles of the disclosure will be described with reference to accompanying drawings. While describing the disclosure, detailed descriptions of related well-known functions or configurations may be omitted when it is deemed that they may unnecessarily obscure the essence of the disclosure. In addition, terms used below are defined based on functions in the disclosure, and may have different meanings according to an intention of a user or operator, customs, or the like. Thus, the terms should be defined based on the description throughout the specification.

For the same reasons, components may be exaggerated, omitted, or schematically illustrated in drawings for clarity. In addition, the size of each component does not completely reflect the actual size. In the drawings, like reference numerals denote like elements.

Advantages and features of the disclosure and methods of accomplishing the same may be understood more readily by reference to the following detailed description of the embodiments of the disclosure and the accompanying drawings. In this regard, the embodiments of the disclosure may have different forms and should not be construed as being limited to the descriptions set forth herein. Rather, these embodiments of the disclosure are provided so that the disclosure will be thorough and complete and will fully convey the concept of the disclosure to one of ordinary skill in the art, and the disclosure will only be defined by the appended claims. Throughout the specification, like reference numerals denote like elements.

Here, it will be understood that combinations of blocks in flowcharts or process flow diagrams may be performed by computer program instructions. Because these computer program instructions may be loaded into a processor of a general-purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-executable or computer-readable memory capable of directing a computer or another programmable data processing apparatus to implement a function in a particular manner, and thus the instructions stored in the computer-executable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

Here, the term “unit” in the embodiments of the disclosure means a software component or hardware component, such as a field-programmable gate array (FPGA) or an application-specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components, such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be divided into additional components and “units”. Furthermore, the components and “units” may be embodied to reproduce one or more central processing units (CPUs) in a device or security multimedia card. In addition, in the embodiments of the disclosure, the “unit” may include at least one processor.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, or the like.

In the disclosure, a controller may also be referred to as a processor.

Throughout the specification, a layer (or a layer apparatus) may also be referred to as an entity.

In addition, terms for identifying access nodes, terms denoting network entities, terms denoting messages, terms denoting interfaces between network entities, terms denoting various types of identification information, and the like, used herein are exemplified for convenience of description. Thus, the terms used in the disclosure are not limited and other terms denoting targets having the same technical meanings may be used.

Hereinafter, a base station is an entity that assigns resources of a terminal, and may be at least one of a next generation node B (gNB), an evolved node B (eNB), a node B (NB), a wireless access unit, a base station controller, or a node on a network. In addition, the term ‘terminal’ may indicate not only mobile phones, narrow band-Internet of things (NB-IoT) devices, and sensors, but also other wireless communication devices. Obviously, the base station and the terminal are not limited to the above examples.

Hereinafter, for convenience of description, the disclosure uses terms and names defined by the 3^{rd} generation partnership project long term evolution (3GPP LTE) standard and the 3GPP new radio (NR) standard. However, the disclosure is not limited by such terms and names, and may be equally applied to systems conforming to other standards.

As a future communication system after the LTE system, that is, a 5^{th} generation (5G) communication system, has to be able to freely reflect various requirements of a user and a service provider, and thus, services satisfying various requirements at the same time need to be supported. The services considered for the 5G communication system include enhanced mobile broadband (eMBB), massive machine type communication (mMTC), ultra-reliability low latency communication (hereinafter, URLLC), and the like.

According to an embodiment of the disclosure, the eMBB aims to provide a higher data rate than a data rate supported by the LTE, LTE-A, or LTE-Pro system. For example, in the 5G communication system, the eMBB should be able to provide a peak data rate of 20 Gbps in a downlink and a peak data rate of 10 Gbps in an uplink from the viewpoint of one base station. In addition, the 5G communication system should provide the increased user perceived data rate of the terminal simultaneously with providing the peak data rate. In order to satisfy such requirements, improvement of various transmitting/receiving technologies including a further improved multiple-input and multiple-output (MIMO) transmission technology may be demanded. In addition, signals are transmitted using a transmission bandwidth of up to 20 MHz in a 2 GHz band used by the current LTE system, but the 5G communication system uses a bandwidth wider than 20 MHz in a frequency band of 3 to 6 GHz or more than 6 GHz, thereby satisfying a data rate required in the 5G communication system.

At the same time, the mMTC is being considered to support application services, such as IoT in the 5G communication system. The mMTC is required for an access support of a large-scale terminal in a cell, coverage enhancement of a terminal, improved battery time, and cost reduction of a terminal in order to efficiently provide the IoT. The IoT needs to be able to support a large number of terminals (e.g., 1,000,000 terminals/km²) in a cell because it includes various sensors and various devices to provide communication functions. In addition, the terminals supporting the mMTC are more likely to be positioned in shaded areas not covered by a cell, such as the underground of a building due to the nature of services, and thus, the terminal requires a wider coverage than other services provided by the 5G communication system. The terminals that support the mMTC should be configured as inexpensive terminals and require very long battery lifetimes, such as 10 to 15 years, because it is difficult to frequently replace batteries of the terminals.

Finally, the URLLC that is a cellular-based wireless communication service used for mission-critical purposes may be used, for example, in remote control for robots or machinery, industrial automation, unmanaged aerial vehicles, remote health care, or emergency alert. Accordingly, communication provided by the URLLC should provide very low latency (ultra-low latency) and very high reliability (ultra-high reliability). For example, a service supporting the URLLC should satisfy air interface latency smaller than 0.5 milliseconds and at the same time, may have a packet error rate of 10⁻⁵ or less. Accordingly, for URLLC-supportive services, the 5G communication system may be required to provide a transmit time interval (TTI) shorter than those for other services while securing reliable communication links by allocating a broad resource in a frequency band.

The three services, that is, eMBB, URLLC, and mMTC, considered in the above 5G communication system may be multiplexed in one system and may be transmitted. In this case, the services may use different transmission and reception methods and transmission and reception parameters in order to meet their different requirements. However, the mMTC, URLLC, and eMBB are examples of different service types, and service types to which the disclosure is applied are not limited thereto.

In addition, although embodiments of the disclosure are described by using the LTE, LTE-A, LTE Pro, or 5G (or NR) system, the embodiments of the disclosure may be applied to other communication systems having a similar technical background or channel type. In addition, it will be understood by one of ordinary skill in the art that embodiments of the disclosure may be applied to other communication systems through some modifications without departing from the scope of the disclosure.

Terms used in the disclosure are used only to describe a specific embodiment of the disclosure, and may not be intended to limit the scope of other embodiments of the disclosure. An expression used in the singular may encompass the expression in the plural, unless it has a clearly different meaning in the context. Terms used herein, including technical or scientific terms, may have the same meaning as commonly understood by one of ordinary skill in the art described in the disclosure. Among terms used in the disclosure, terms defined in a general dictionary may be interpreted as having the same or similar meanings as those in the context of the related technology, and unless explicitly defined in the disclosure, the terms are not interpreted in ideal or excessively formal meanings. In some cases, even terms defined in the disclosure cannot be interpreted to exclude embodiments of the disclosure.

In various embodiments of the disclosure described below, a hardware approach is described as an example. However, because various embodiments of the disclosure include technology using both hardware and software, various embodiments of the disclosure do not exclude a software-based approach.

The disclosure hereinbelow relates to a method and an apparatus for supporting various services in a wireless communication system. More particularly, the disclosure describes a technology for supporting various services by supporting mobility of a terminal in a wireless communication system.

For convenience of description, a name of a network function (NF) (for example, an access and mobility management function (AMF), a session management function (SMF), or network slice selection function (NSSF)) is used as a target for exchanging information for access control and state management. However, the embodiments of the disclosure may be identically applied even when an NF is implemented as an instance (for example, AMF instance, SMF instance, or an NSSF instance).

Hereinafter, embodiments of the disclosure will be described with reference to accompanying drawings.

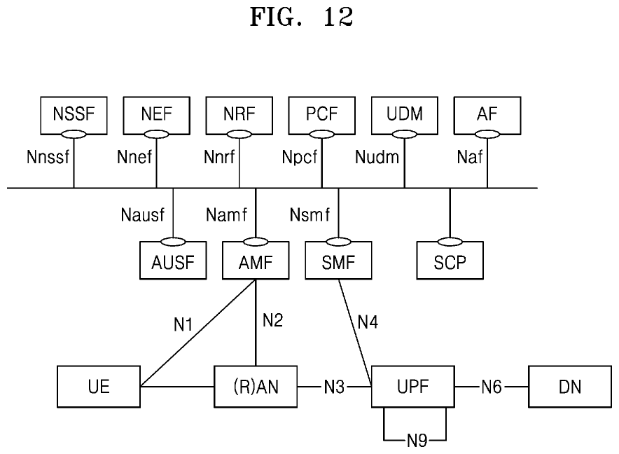

FIG. 12 is a diagram of a wireless communication system according to an embodiment of the disclosure.

Referring to FIG. 12, a 5G system (5GS) may include a new ratio (NR) base station, an AMF, an SMF, a user plane function (UPF), a policy control function (PCF), and a unified data management (UDM).

According to an embodiment of the disclosure, the AMF may be an NF of managing access of the UE to a wireless network and mobility of the UE. The SMF may be an NF for managing packet data network connection provided to the UE. The UPF may perform a function of a gateway delivering a packet transmitted/received by the UE and may be an NF controlled by the SMF. The PCF may be an NF for applying a service policy, a charging policy, and a protocol data unit (PDU) session policy of a mobile communication operator on the UE. The UDM may be an NF for storing and managing information about a subscriber. Obviously, a configuration of the 5GS is not limited to the above. For example, the configuration of the 5GS may include more or fewer NFs described above, and functions of the NFs may vary without limitation.

Referring to FIG. 12, the base station (or a (radio) access network ((R)AN)) and the UE are illustrated as some of nodes using a wireless channel in the wireless communication system. In FIG. 12, only one base station ((R)AN) is illustrated, but the wireless communication system may further include another base station that is the same as or similar to the base station ((R)AN).

The base station ((R)AN) is a network infrastructure providing a wireless access to the UE. The base station ((R)AN) has a coverage defined as a certain geographic area based on a distance at which a signal is transmittable. The base station ((R)AN) may be referred to by, in addition to the base station, an access point (AP), an evolved node B (eNB), a 5G node, a wireless point, a transmission/reception point (TRP), or another term having an equivalent technical meaning.

The UE is an apparatus used by a user and performs communication with the base station ((R)AN) via a wireless channel. In some cases, the UE may be operated without the user's involvement. For example, the UE may be an apparatus performing machine type communication (MTC) and may not be carried by the user. The UE may be referred to as the terminal, a mobile station, a subscriber station, a remote terminal, a wireless terminal, a user device, or another term having an equivalent technical meaning.

Hereinafter, for convenience of description, targets exchanging information for access control and state management will be collectively described as NFs. The NF may be at least one of, for example, an AMF device, an SMF device, or a network slice selection function (NSSF) device. However, embodiments of the disclosure may be identically applied even when the NF is implemented as an instance (for example, an AMF instance, SMF instance, or NSSF instance).

In the disclosure, the instance may refer to a specific NF present in a form of software code. For example, the instance may denote a state in which physical and/or logical resources for performing a function of the NF are assigned from a physical computing system, such as a specific computing system present on a core network, and are executable. Accordingly, the AMF instance, the SMF instance, and the NSSF instance may denote instances in which physical/logical resources are assigned from a specific computing system present on a core network and used for operations of the AMF, SMF, or NSSF, respectively. As a result, the physical AMF, SMF, and NSSF devices may perform the same operations as the AMF instance, the SMF instance, and the NSSF instance, which are assigned with and use physical/logical resources from a specific computing system present on a network for operations of the AMF, SMF, or NSSF, respectively. Accordingly, in embodiments of the disclosure, matters described as an NF (AMF, SMF, UPF, NSSF, network repository function (NRF), or service communication proxy (SCP)) may be replaced by an NF instance or vice versa. Similarly, in embodiments of the disclosure, matters described as a network (NW) slice may be replaced by an NW slice instance or vice versa.

According to an embodiment of the disclosure, in the 5G system defined by 3GPP, one network slice may be referred to as single-network slice selection assistance information (S-NSSAI). The network slice may be simply referred to as a slice. The S-NSSAI may include a slice/service type (SST) value and a slice differentiator (SD) value. The SST value may indicate a characteristic (for example, enhanced mobile broadband (eMBB), Internet of things (IoT), ultra-reliable low-latency communications (URLLC), vehicle-to-everything (V2X), or the like) of a service supported by a slice. The SD value may be a value used as an additional indicator for a specific service indicated by the SST value.

NSSAI may include one or more pieces of S-NSSAI (i.e., S-NSSAI(s)). For example, the NSSAI may include at least one of configured NSSAI stored in a UE, requested NSSAI requested by a UE, allowed NSSAI allowed to be used by a UE and determined by an NF (for example, AMF, NSSF, or the like) of a 5G core network, or subscribed NSSAI to which a UE is subscribed. However, a type of the NSSAI is not limited thereto and may vary.

According to an embodiment of the disclosure, a data rate may be applied to a downlink or an uplink (for example, an NW slice aggregated maximum bit rate for downlink or NW slice aggregated maximum bit rate for uplink). When a separate value is applied for the uplink and the downlink, signaling may also be separately delivered.

Hereinafter, a first embodiment of the disclosure will be described.

### First Embodiment

The first embodiment of the disclosure relates to a method by which a mobile carrier (public land mobile network (PLMN) or operator) defines a data rate supportable in one network slice (S-NSSAI) or one SST, and configures or provisions the defined supportable data rate to an NF configuring a base station or 5G core network (5GC).

According to an embodiment of the disclosure, the mobile carrier may define a maximum number of PDU sessions established in one network slice (S-NSSAI) or one SST, an average data rate or maximum data rate used by one PDU session, an average data rate or maximum data rate used by all PDU sessions, and a total data amount generated in a network slice for a certain period of time.

For example, the mobile carrier may define the maximum number of PDU sessions established in one network slice (S-NSSAI) or one SST to be one million PDU sessions, the average data rate or maximum data rate used by one PUD session to be 100 Mbps, the average data rate or maximum data rate used by all PDU sessions to be 100 million Mbps (for example, a value equal to or less than a value obtained by multiplying one million PDU sessions, i.e., the maximum number of PDU sessions, and 100 Mbps, i.e., the average/maximum data rate), and the total data amount generated in a network slice for a certain period of time to be 1,000 terabytes per month. The mobile carrier may determine the data rate supportable in the network slice based on a local policy or based on a service level agreement (SLA) with a third-party service provider using the network slice.

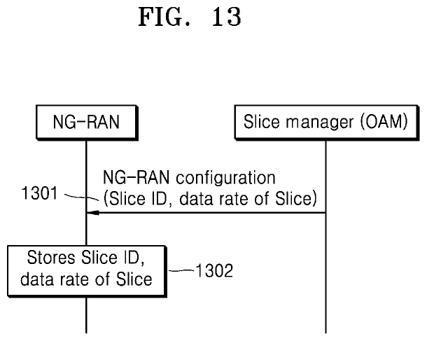

FIG. 13 is a flow diagram for describing a method by which a base station is configured with a data rate of a network slice from a slice manager (operations, administration, and maintenance (OAM) according to an embodiment of the disclosure.

Referring to FIG. 13, the slice manager (OAM) may manage the data rate of the network slice. In operation 1301, the slice manager (OAM) may transmit a message including new generation (NG)-RAN (NG-RAN) configuration information to the base station (NG-RAN). The NG-RAN configuration information may include information about a slice ID (S-NSSAI or SST) and the data rate of the network slice. The data rate of the network slice may include an average data rate or maximum data rate (for example, 100 Mbps) used by one PDU session supported in the network slice indicated by the slice ID.

In addition, the data rate of the network slice may include a maximum data rate enforceable by the base station. The OAM may determine the maximum data rate enforceable by the base station based on a base station deployment status. For example, when 10,000 base stations supporting the network slice indicated by the slice ID are deployed and an average data rate or maximum data rate used by all PDU sessions using the network slice indicated by the slice ID is 100 million Mbps, the OAM may determine the maximum data rate enforceable by one base station to be 10,000 Mbps (for example, a value obtained by dividing 100 million Mbps, i.e., the total data rate, by 10,000 base stations, i.e., the total number of base stations). The OAM may add the determined maximum data rate to the NG-RAN configuration information and transmit the NG-RAN configuration information to the base station through the message of operation 1301.

In operation 1302, the base station may store the slice ID and data rate configured by the OAM.

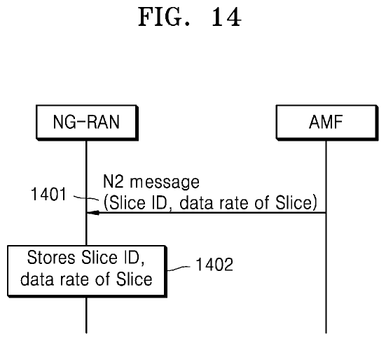

FIG. 14 is a flow diagram for describing a method by which a base station is configured with a data rate of a network slice from an AMF according to an embodiment of the disclosure.

Referring to FIG. 14, the AMF may manage the data rate of the network slice. In operation 1401, the AMF may be configured with the data rate of the network slice from an OAM. The AMF may add, to an N2 message transmitted to a base station (NG-RAN), information about a slice ID (S-NSSAI or SST) and a data rate of a network slice indicated by the slice ID, and transmit the N2 message to the base station. The data rate of the network slice may include an average data rate or maximum data rate (for example, 100 Mbps) used by one PDU session supported in the network slice indicated by the slice ID. The N2 message may be a UE specific message or a non-UE specific message generated during a UE-related procedure (for example, registration, PDU session establishment, service request, or UE configuration update).

In addition, the data rate of the network slice may include a maximum data rate enforceable by the base station. The AMF may determine the maximum data rate enforceable by the base station based on a base station deployment status. For example, when 10,000 base stations supporting the network slice indicated by the slice ID are deployed and an average data rate or maximum data rate used by all PDU sessions using the network slice indicated by the slice ID is 100 million Mbps, the AMF may determine the maximum data rate enforceable by one base station to be 10,000 Mbps (for example, a value obtained by dividing 100 million Mbps, i.e., the total data rate, by 10,000 base stations, i.e., the total number of base stations). The AMF may add the determined maximum data rate to the N2 message of operation 1401 and transmit the N2 message to the base station.

In operation 1402, the base station may store the slice ID and data rate received from the AMF.

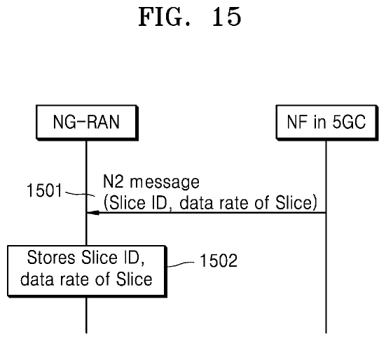

FIG. 15 is a flow diagram for describing a method by which a base station (NG-RAN) is configured with a data rate of a network slice from an NF according to an embodiment of the disclosure.

Referring to FIG. 15, the NF (for example, SMF, PCF, NSSF, NRF, or UDM) may manage the data rate of the network slice. In operation 1501, the NF may be configured with the data rate of the network slice from an OAM. The NF AMF may add, to an N2 message transmitted to a base station (NG-RAN) through an AMF, information about a slice ID (S-NSSAI or SST) and a data rate of a network slice indicated by the slice ID, and transmit the N2 message to the base station. The data rate of the network slice may include an average data rate or maximum data rate (for example, 100 Mbps) used by one PDU session supported in the network slice indicated by the slice ID.

In addition, the data rate of the network slice may include a maximum data rate enforceable by the base station. The NF may determine the maximum data rate enforceable by the base station based on a base station deployment status. For example, when 10,000 base stations supporting the network slice indicated by the slice ID are deployed and an average data rate or maximum data rate used by all PDU sessions using the network slice indicated by the slice ID is 100 million Mbps, the NF may determine the maximum data rate enforceable by one base station to be 10,000 Mbps (for example, a value obtained by dividing 100 million Mbps, i.e., the total data rate, by 10,000 base stations, i.e., the total number of base stations). The NF may add the determined maximum data rate to the N2 message of operation 1501 and transmit the N2 message to the base station.

In other words, the NF may transmit the slice ID and the information about the data rate of the network slice to the AMF, and the AMF may add the information received from the NF to the N2 message and transmit the N2 message to the base station. The N2 message may be a UE specific message or a non-UE specific message generated during a UE-related procedure (for example, registration, PDU session establishment, service request, or UE configuration update).

In operation 1502, the base station may store the slice ID and data rate received from the NF.

Hereinafter, a second embodiment of the disclosure will be described.

### Second Embodiment

The second embodiment of the disclosure relates to a method by which a base station controls a data rate per network slice.

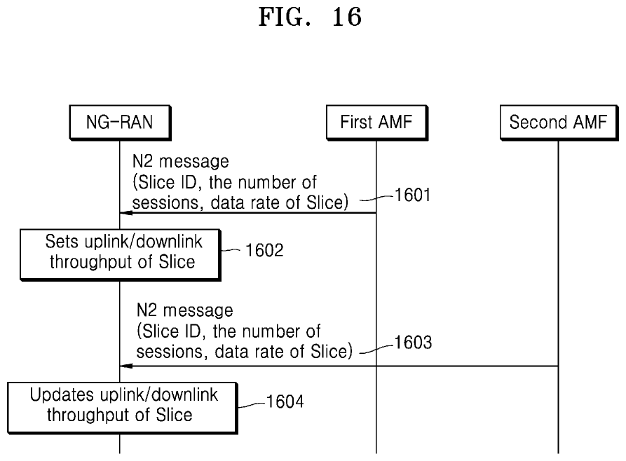

FIG. 16 is a flow diagram for describing a method by which a base station (NG-RAN) receives information about a network slice from an AMF according to an embodiment of the disclosure.

Referring to FIG. 16, in operation 1601, a first AMF may add, to an N2 message, at least one of a slice ID (S-NSSAI or SST) or a number of PDU sessions established in a network slice indicated by the slice ID, and transmit the N2 message to the base station. The number of PDU sessions may be a total number of PDU sessions established in the network slice indicated by the slice ID for UEs supported (served) by the first AMF. For example, when the first AMF currently supports 100 UEs and the number of PDU sessions including an active user plane established in the network slice indicated by the slice ID for the 100 UEs is 20, the first AMF may add 20 as the number of PDU sessions to a message of operation 1601.

In addition, the first AMF may add a data rate of the network slice to the message of operation 1601. For example, the data rate may be a value (for example, 100 Mbps) indicating an average data rate or a maximum data rate available to one PDU session. Alternatively, the data rate may be a value (for example, 2,000 Mbps obtained by multiplying 20 sessions by 100 Mbps) indicating a total average data rate or total maximum data rate available to all PDU sessions supported by the first AMF.

In operation 1602, the base station may determine a total slice data rate by using the received value.

According to an embodiment of the disclosure, the base station may determine a value obtained by multiplying the data rate of one PDU session stored via the method described in the first embodiment of the disclosure and the number of PDU sessions received in operation 1601, as the total slice data rate. For example, when the base station received 20 as the number of PDU sessions in operation 1601, the base station may determine the total slice data rate to be 2,000 Mbps based on the data rate 100 Mbps of one PDU session stored via the method described in the first embodiment of the disclosure.

Alternatively, the base station may determine a value obtained by multiplying the data rate of one PDU session received in operation 1601 and the number of PDU sessions received in operation 1601, as the total slice data rate. For example, when the base station received 20 as the number of PDU sessions in operation 1601 and received 100 Mbps as the data rate of one PDU session, the base station may determine 2,000 Mbps as the total slice data rate.

Alternatively, the base station may determine the data rate of all PDU sessions received in operation 1601 as the total slice data rate. For example, when the base station received 2,000 Mbps as the data rate of all PDU sessions in operation 1601, the base station may determine the total slice data rate to be 2,000 Mbps.

The base station may compare the total slice data rate determined in operation 1602 with a maximum data rate (for example, 10,000 Mbps) enforceable by the base station stored via the method of the first embodiment of the disclosure. When the total slice data rate determined in operation 1601 does not exceed the maximum data rate (for example, 10,000 Mbps) enforceable by the base station, the base station may control an uplink and/or downlink data rate by using the total slice data rate determined in operation 1601. Alternatively, when the total slice data rate determined in operation 1601 exceeds the maximum data rate (for example, 10,000 Mbps) enforceable by the base station, the base station may control the uplink and/or downlink data rate by configuring the total slice data rate as the maximum data rate (for example, 10,000 Mbps) enforceable by the base station. In this case, the base station may transmit, to the first AMF, information indicating that the base station is unable to support the data rate of the network slice received from the first AMF in operation 1601.

According to an embodiment of the disclosure, the base station may be connected to one or more AMFs. In operation 1603, a second AMF may transmit an N2 message to the base station. The N2 message may include at least one of a slice ID (S-NSSAI or SST) or a number of PDU sessions established in a network slice indicated by the slice ID. Hereinafter, while describing operation 1604, it is assumed that the number of PDU sessions supported by the second AMF included in the N2 message of operation 1603 is 30 for convenience of description.

In operation 1604, the base station may update the total slice data rate determined in operation 1602, based on the information received from the second AMF. First, the base station may identify the slice ID received in operation 1603 and determine whether the data rate is currently controlled via the corresponding slice ID. When the base station is currently controlling the data rate via the corresponding slice ID (for example, when the slice ID of operation 1601 and the slice ID of operation 1603 are identical), the base station may determine the total slice data rate by using the information received from the first AMF in operation 1601 and the information received from the second AMF in operation 1603.

A method by which the base station determines the data rate (for example, 3,000 Mbps) according to the number of PDU sessions (for example, 30 PDU sessions) supported by the second AMF, in operation 1604, may use the method described with reference to operation 1602.

For example, when the base station determined the total slice data rate (for example, 2,000 Mbps) for the network slice indicated by the slice ID in operation 1602 and is enforcing data transmission/reception, because the PDU sessions (for example, 30 PDU sessions) supported by the second AMF is added in operation 1603, the base station may update the total slice data rate (for example 5,000 Mbps) by adding the data rate (for example, 3,000 Mbps) corresponding to the PDU sessions (for example, 30 PDU sessions) supported by the second AMF.

The base station may compare the total slice data rate determined in operation 1604 with a maximum data rate (for example, 10,000 Mbps) enforceable by the base station stored via the method of the first embodiment of the disclosure. When the total slice data rate determined in operation 1604 does not exceed the maximum data rate (for example, 10,000 Mbps) enforceable by the base station, the base station may control the uplink and/or downlink data rate by using the total slice data rate. When the total slice data rate determined in operation 1604 exceeds the maximum data rate (for example, 10,000 Mbps) enforceable by the base station, the base station may control the uplink and/or downlink data rate by configuring the total slice data rate as the maximum data rate (for example, 10,000 Mbps) enforceable by the base station. In this case, the base station may transmit, to at least one of the first AMF or the second AMF, information indicating that the base station is unable to support the data rate of the network slice received from the first AMF and the second AMF in operations 1601 and 1603.

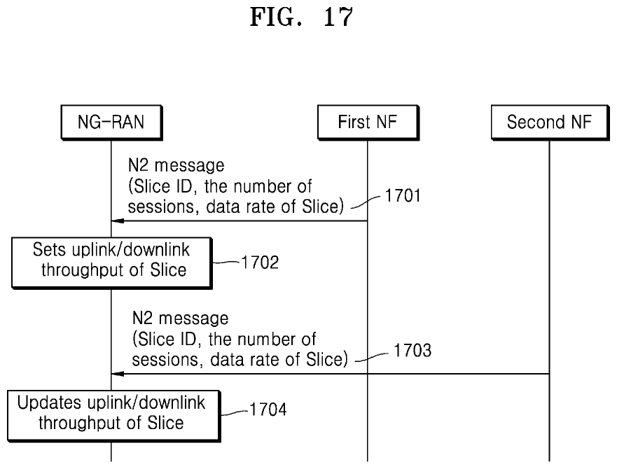

FIG. 17 is a flow diagram for describing a method by which a base station (NG-RAN) receives information about a network slice from an NF according to an embodiment of the disclosure.

Referring to FIG. 17, in operation 1701, a first NF (for example, SMF, PCF, NSSF, URF, or UDM) may add, to an N2 message transmitted to the base station via an AMF, at least one of a slice ID (S-NSSAI or SST) or a number of PDU sessions established in a network slice indicated by the slice ID, and transmit the N2 message to the base station. The number of PDU sessions may be a total number of PDU sessions established in the network slice indicated by the slice ID for UEs supported (served) by the first NF. For example, when the first NF currently supports 100 UEs and the number of PDU sessions including an active user plane established in the network slice indicated by the slice ID for the 100 UEs is 20, the first NF may add 20 as the number of PDU sessions to a message of operation 1701.

In addition, the first NF may add a data rate of the network slice to the message of operation 1701. For example, the data rate may be a value (for example, 100 Mbps) indicating an average data rate or a maximum data rate available to one PDU session. Alternatively, the data rate may be a value (for example, 2,000 Mbps obtained by multiplying 20 sessions by 100 Mbps) indicating a total average data rate or total maximum data rate available to all PDU sessions supported by the first NF.

The AMF may add the information received from the first NF to the N2 message and transmit the N2 message to the base station. The N2 message may be a UE specific message or a non-UE specific message generated during a UE-related procedure (for example, registration, PDU session establishment, service request, or UE configuration update).

In operation 1702, the base station may determine a total slice data rate by using the received value.

According to an embodiment of the disclosure, the base station may determine a value obtained by multiplying the data rate of one PDU session stored via the method described in the first embodiment of the disclosure and the number of PDU sessions received in operation 1701, as the total slice data rate. For example, when the base station received 20 as the number of PDU sessions in operation 1701, the base station may determine the total slice data rate to be 2,000 Mbps based on the data rate 100 Mbps of one PDU session stored via the method described in the first embodiment of the disclosure.

Alternatively, the base station may determine a value obtained by multiplying the data rate of one PDU session received in operation 1701 and the number of PDU sessions received in operation 1701, as the total slice data rate. For example, when the base station received 20 as the number of PDU sessions in operation 1701 and received 100 Mbps as the data rate of one PDU session, the base station may determine 2,000 Mbps as the total slice data rate.

Alternatively, the base station may determine the data rate of all PDU sessions received in operation 1701 as the total slice data rate. For example, when the base station received 2,000 Mbps as the data rate of all PDU sessions in operation 1701, the base station may determine the total slice data rate to be 2,000 Mbps.

The base station may compare the total slice data rate determined in operation 1702 with a maximum data rate (for example, 10,000 Mbps) enforceable by the base station stored via the method of the first embodiment of the disclosure. When the total slice data rate determined in operation 1701 does not exceed the maximum data rate (for example, 10,000 Mbps) enforceable by the base station, the base station may control an uplink and/or downlink data rate by using the total slice data rate determined in operation 1701. Alternatively, when the total slice data rate determined in operation 1701 exceeds the maximum data rate (for example, 10,000 Mbps) enforceable by the base station, the base station may control the uplink and/or downlink data rate by configuring the total slice data rate as the maximum data rate (for example, 10,000 Mbps) enforceable by the base station. In this case, the base station may transmit, to the first NF, information indicating that the base station is unable to support the data rate of the network slice received from the first NF in operation 1701.

According to an embodiment of the disclosure, one or more NFs may support a same network slice (same S-NSSAI or same SST). In operation 1703, a second NF may transmit an N2 message to the base station through the AMF. The N2 message may include at least one of a slice ID (S-NSSAI or SST) or a number of PDU sessions established in a network slice indicated by the slice ID. Hereinafter, while describing operation 1704, it is assumed that the number of PDU sessions supported by the second NF is 30, for convenience of description.

In operation 1704, the base station may update the total slice data rate determined in operation 1702, based on the information received from the second NF. First, the base station may identify the slice ID received in operation 1703 and determine whether the data rate is currently controlled via the corresponding slice ID. When the base station is currently controlling the data rate via the corresponding slice ID (for example, when the slice ID of operation 1701 and the slice ID of operation 1703 are identical), the base station may determine the total slice data rate by using the information received from the first NF in operation 1701 and the information received from the second NF in operation 1703.

A method by which the base station determines the data rate (for example, 3,000 Mbps) according to the number of PDU sessions (for example, 30 PDU sessions) supported by the second NF, in operation 1704, may use the method described with reference to operation 1702.

For example, when the base station determined the total slice data rate (for example, 2,000 Mbps) for the network slice indicated by the slice ID in operation 1702 and is enforcing data transmission/reception, because the PDU sessions (for example, 30 PDU sessions) supported by the second NF is added in operation 1703, the base station may update the total slice data rate (for example 5,000 Mbps) by adding the data rate (for example, 3,000 Mbps) corresponding to the PDU sessions (for example, 30 PDU sessions) supported by the second NF.

The base station may compare the total slice data rate determined in operation 1704 with a maximum data rate (for example, 10,000 Mbps) enforceable by the base station stored via the method of the first embodiment of the disclosure. When the total slice data rate determined in operation 1704 does not exceed the maximum data rate (for example, 10,000 Mbps) enforceable by the base station, the base station may control the uplink and/or downlink data rate by using the total slice data rate. When the total slice data rate determined in operation 1704 exceeds the maximum data rate (for example, 10,000 Mbps) enforceable by the base station, the base station may control the uplink and/or downlink data rate by configuring the total slice data rate as the maximum data rate (for example, 10,000 Mbps) enforceable by the base station. In this case, the base station may transmit, to at least one of the first NF or the second NF, information indicating that the base station is unable to support the data rate of the network slice received from the first NF and the second NF in operations 1701 and 1703.

The data rate configured by the base station in the second embodiment of the disclosure may be used by the base station to control the uplink and downlink data rates. Alternatively, a data rate for uplink data and a data rate for downlink data may be separately calculated as described in the second embodiment of the disclosure to be respectively used to control the uplink data rate and the downlink data rate.

Hereinafter, a third embodiment of the disclosure will be described.

### Third Embodiment

According to an embodiment of the disclosure, in the first embodiment of the disclosure described above, an average data rate or maximum data rate (for example, 100 Mbps) used by one PDU supported by a network slice (S-NSSAI or SST), a maximum number of PDU sessions (for example, million PDU sessions) establishable in association with a network slice, an average data rate or maximum data rate (for example, 100 million Mbps, a value equal to or smaller than a value obtained by multiplying million PDU sessions, i.e., the maximum number of PDU sessions, and 100 Mbps, i.e., the average/maximum data rate) used by all PDU sessions, and a total data amount generated in a network slice for a certain period of time (for example, 1,000 terabytes per month) may be defined. The data rate described in the first embodiment of the disclosure may be identically applied for uplink data transmission and downlink data transmission. Alternatively, a data rate for uplink data transmission and a data rate for downlink data transmission may be separately defined according to the details described in the first embodiment of the disclosure.

According to an embodiment of the disclosure, in the second embodiment of the disclosure described above, a method of calculating a total slice data rate (for example, 5,000 Mbps) enforced by a base station may be defined. The data rate described in the second embodiment of the disclosure may be identically applied for uplink data transmission and downlink data transmission. Alternatively, a data rate for uplink data transmission and a data rate for downlink data transmission may be separately defined according to the details described in the second embodiment of the disclosure.

In the third embodiment of the disclosure, a method of configuring the data rate described in the first or second embodiment of the disclosure is described. Hereinafter, a data rate described below may be identically applied for uplink data transmission and downlink data transmission. Alternatively, a data rate for uplink data transmission and a data rate for downlink data transmission may be separately defined according to a method described below.

According to an embodiment of the disclosure, a data rate used by one PDU session, a data rate used by all PDU sessions, or a maximum data rate enforceable by a base station, which is received by the base station from an OAM, AMF, or NF according to the method described in the first embodiment of the disclosure, may include both a data rate of data transmitted on guaranteed bit rate (GBR) quality of service (QoS) flows and a data rate of data transmitted on non-GBR QoS flows.

According to an embodiment of the disclosure, the data rate used by one PDU session, the data rate used by all PDU sessions, or the maximum data rate enforceable by the base station, which is received by the base station from the OAM, AMF, or NF according to the method described in the first embodiment of the disclosure, may include only the data rate of data transmitted on the non-GBR QoS flows and not the data rate of data transmitted on GBR QoS flows.

According to an embodiment of the disclosure, a data rate of a network slice received by the base station from the AMF or NF according to the method described in the second embodiment of the disclosure may include both the data rate of data transmitted on the GBR QoS flows and the data rate of data transmitted on the non-GBR QoS flows. The base station may determine the data rate of data transmitted on the GBR QoS flows and the data rate of data transmitted on the non-GBR QoS flows, based on at least one of information stored in the base station or information received from the AMF or NF.

For example, the data rate of the network slice may include, for GBR QoS flow(s), at least one of a GBR, a guaranteed flow bit rate (GFBR), a maximum bit rate (MBR), or a maximum flow bit rate (MFBR). In addition, the data rate of the network slice may include an aggregated maximum bit rate (AMBR) for the non-GBR QoS flow(s). At least one data rate from among the GBR, the GFBR, the MBR, the MFBR, or the AMBR may be a value defined for a session or a value defined for a slice.

Alternatively, for example, the data rate of the network slice may include one total maximum bit rate (TMBR) including both the data rate for GBR QoS flow(s) and the data rate for non-GBR QoS flow(s), without the data rate for GBR QoS flow(s) and the data rate for non-GBR QoS flow(s) being distinguished. Thus, the total slice data rate determined by the base station in the second embodiment of the disclosure may include both the data rate of data transmitted on the GBR QoS flows and the data rate of data transmitted on the non-GBR QoS flows. The base station may use, as the data rate of data transmitted on the non-GBR QoS flows, a value obtained by excluding the data rate of data transmitted on the GBR QoS flows from the total slice data rate. For example, when the total slice data rate is 5,000 Mbps and the data rate of data transmitted on the GBR QoS flows is 3,500 Mbps, the base station may configure the data rate of data transmitted on the non-GBR QoS flows to be 1,500 Mbps. The base station may enforce each of a data rate restriction of the GBR QoS flows and a data rate restriction of the non-GBR QoS flows by using the received/determined data rate of the network slice. For example, the base station may enforce 3,500 Mbps as the data rate restriction of the GBR QoS flows from among 5,000 Mbps, i.e., the received/determined data rate of the network slice, and enforce remaining 1,500 Mbps as the data rate restriction of the non-GBR QoS flows.

When the total slice data rate is to be adjusted (for example, to be reduced), the base station may first adjust or reduce the data rate of data transmitted on the non-GBR QoS flows. For example, when the total slice data rate is to be reduced from 5,000 Mbps to 4,000 Mbps, the base station may not change the data rate 3,500 Mbps of data transmitted on the GBR QoS flows, but may change the data rate of data transmitted on the non-GBR QoS flows from 1,500 Mbps to 500 Mbps. The base station may enforce 3,500 Mbps as the data rate restriction of the GBR QoS flows from among 4,000 Mbps, i.e., the received/determined data rate of the network slice, and enforce remaining 500 Mbps as the data rate restriction of the non-GBR QoS flows.

According to an embodiment of the disclosure, a data rate of a network slice received by the base station from the AMF or NF according to the method described in the second embodiment of the disclosure may not include the data rate of data transmitted on the GBR QoS flows, and may include only the data rate of data transmitted on the non-GBR QoS flows. The base station may determine the data rate of data transmitted on the GBR QoS flows and the data rate of data transmitted on the non-GBR QoS flows, based on at least one of information stored in the base station or information received from the AMF or NF.

For example, the data rate of the network slice managed by the AMF or NF may include at least one of the GBR, the GFBR, the MBR, or the MFBR for the GBR QoS flow(s). In addition, the data rate of the network slice may include the AMBR for the non-GBR QoS flow(s). At least one data rate from among the GBR, the GFBR, the MBR, the MFBR, or the AMBR may be a value defined for a session or a value defined for a slice.

Alternatively, for example, the data rate of the network slice managed by the AMF or NF may include one total maximum bit rate (TMBR) including both the data rate for GBR QoS flow(s) and the data rate for non-GBR QoS flow(s), without the data rate for GBR QoS flow(s) and the data rate for non-GBR QoS flow(s) being distinguished.

Accordingly, the AMF or NF may transmit, to the base station, only a data rate considering the data transmitted on the non-GBR QoS flows excluding the data rate of data transmitted on the GBR QoS flows, from among the data rate of the network slice including the data rate of data transmitted on the GBR QoS flows and the data rate of data transmitted on the non-GBR QoS flows. For example, when the total slice data rate is 5,000 Mbps and the data rate of data transmitted on the GBR QoS flows is 3,500 Mbps, the AMF or NF may configure the data rate of data transmitted on the non-GBR QoS flows to be 1,500 Mbps. In this case, the data rate of the network slice received by the base station from the AMF or NF may be 1,500 Mbps according to the method described in the second embodiment of the disclosure. For the data rate restriction of the non-GBR QoS flows, the base station may enforce the received/determined 1,500 Mbps.

When the total slice data rate is to be adjusted (for example, to be reduced), the AMF or NF may first adjust or reduce the data rate of data transmitted on the non-GBR QoS flows. For example, when the total slice data rate is to be reduced from 5,000 Mbps to 4,000 Mbps, the AMF or NF may not change the data rate 3,500 Mbps of data transmitted on the GBR QoS flows, but may change the data rate of data transmitted on the non-GBR QoS flows from 1,500 Mbps to 500 Mbps. The AMF or NF may transmit, to the base station, the changed data rate, i.e., 500 Mbps. For the data rate restriction of the non-GBR QoS flows, the base station may enforce the received/determined 500 Mbps.

Hereinafter, a fourth embodiment of the disclosure will be described.

### Fourth Embodiment

The fourth embodiment of the disclosure relates to a method by which a base station monitors and reports statuses of a data rate per network slice and data usage.

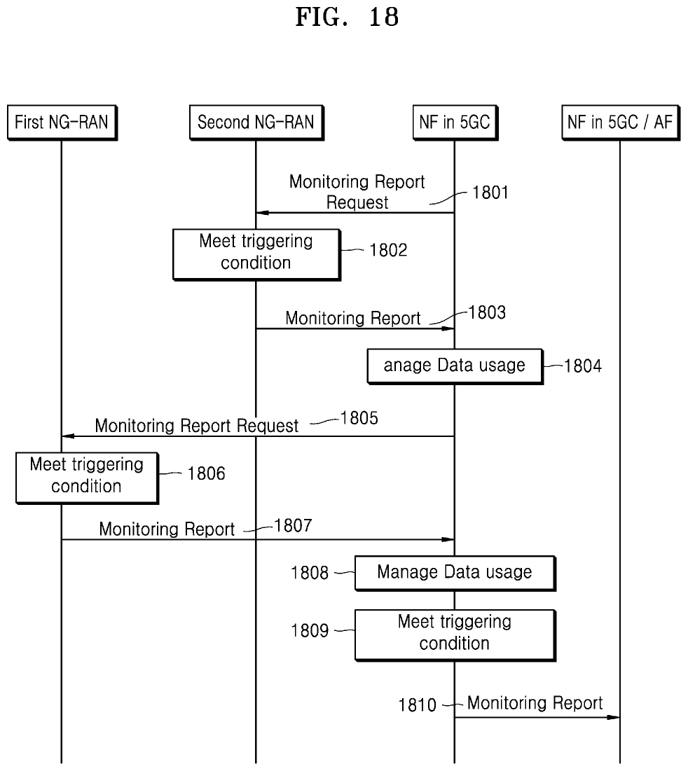

FIG. 18 is a flow diagram for describing a method by which a base station (NG-RAN) monitors and reports statuses of a data rate per network slice and data usage according to an embodiment of the disclosure.

Referring to FIG. 18, an NF (for example, SMF, PCF, NSSF, NRF, or UDM) may manage a data rate of a network slice. The NF may manage information (for example, an RAN node ID, a cell ID, or the like) of the base station supporting a network slice indicated by a slice ID (S-NSSAI or SST). In operation 1801, the NF may request a first base station for a monitoring report of the data rate of the network slice via an AMF. For example, the NF is an NF managing a data rate of an eMBB slice (eMBB S-NSSAI or eMBB SST) and is aware that the first base station and a second base station support the eMBB slice. The NF may transmit a monitoring report request message to the first base station in operation 1801. In addition, the NF may transmit the monitoring report request message to the second base station in operation 1805.

The monitoring report request messages of operations 1801 and 1805 may include a slice ID and a monitoring condition related to the network slice. For example, the monitoring condition may include time (period) information for transmitting a monitoring report message, data usage information for transmitting the monitoring report message, and event information for transmitting the monitoring report message.

In operation 1802, the first base station may store the slice ID and the monitoring condition received in operation 1801, and determine whether the monitoring condition is satisfied.

For example, when the monitoring condition includes the time (period) information (for example, once every 2 hours, once a day, or 4 in the morning), the first base station may transmit a message of operation 1803 when it is a time or period according to the monitoring condition.

For example, when the monitoring condition includes the data usage information (for example, an accumulated data usage of 1 terabyte), the first base station may transmit the message of operation 1803 when an accumulated data usage in the network slice indicated by the slice ID reaches a data usage stated in the monitoring condition.

For example, when the monitoring condition includes the event information (for example, when a requested slice data rate is not satisfied or a maximum data rate enforceable by a base station is reached), the first base station may transmit the message of operation 1803 when a corresponding event occurs.

In operation 1803, the first base station may transmit a monitoring report to the NF. The monitoring report may include at least one of the slice ID, the accumulated data usage, a current data rate, an error status, or occurred event information.

In operation 1804, the NF may store and manage the data usage information about the slice ID, which is received from the first base station.

In operations 1805 through 1808, when one or more base stations support a network slice, the NF may perform operations 1801 through 1804 with the base stations supporting the network slice. Herein, for convenience of description, transmission/reception of messages between the NF and the first base station has been described first in operations 1801 through 1804 and transmission/reception of messages between the NF and the second base station has been described later in operations 1805 through 1808. However, the transmission/reception of messages between the NF and the first base station and the transmission/reception of messages between the NF and the second base station may be independently performed. In other words, an order of performing operations 1801 through 1808 is not limited to that shown in FIG. 18 and may vary.

In operation 1809, the NF may collectively manage and monitor the data usage of the network slice, based on information collected from the base stations supporting the network slice.

For example, the accumulated data usage of the network slice managed by the NF may be a sum of an accumulated data usage received from the first base station in operation 1803 and an accumulated data usage received from the second base station in operation 1807.

The NF may determine whether the monitoring condition is satisfied based on the information collected from the first and second base stations.

For example, when the monitoring condition includes the time (period) information (for example, once every 2 hours, once a day, or 4 in the morning), the NF may transmit, to another NF or an AF, a message (a monitoring report) of operation 1810 when it is a time or period according to the monitoring condition.

For example, when the monitoring condition includes the data usage information (for example, an accumulated data usage of 1 terabyte), the NF may transmit, to the other NF or the AF, the message (monitoring report) of operation 1810 when the accumulated data usage in the network slice indicated by the slice ID reaches the data usage stated in the monitoring condition.

For example, when the monitoring condition includes the event information (for example, when a requested slice data rate is not satisfied, when an average data rate or maximum data rate (for example, 100 million Mbps) used by all PDU sessions using a corresponding network slice is reached, when a data usage for a certain period of time reaches a total data amount (for example, 100 terabytes per month) generated in a network slice), the NF may transmit the message (monitoring report) of operation 1810 to the other NF or the AF when a corresponding event occurs.

In operation 1810, the NF may transmit a data usage monitoring report to the other NF or the AF. The data usage monitoring report may include at least one of the slice ID, the accumulated data usage, the current data rate, the error status, the occurred event information, or a number of rejected PDU sessions.

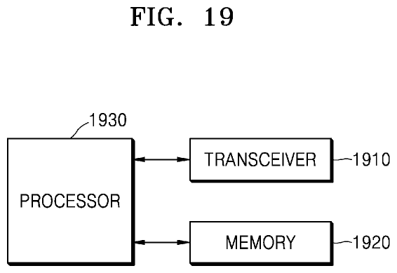

FIG. 19 is a block diagram of a configuration of a UE according to an embodiment of the disclosure. The UE described above may correspond to the UE of FIG. 19.

Referring to FIG. 19, the UE may include a transceiver 1910, a memory 1920, and a processor 1930. The transceiver 1910, the memory 1920, and the processor 1930 of the UE may operate according to a communication method of the UE described above. However, the components of the UE are not limited thereto. For example, the UE may include more or fewer components than those described above. In addition, the transceiver 1910, processor 1930, and the memory 1920 may be implemented as a single chip. In addition, the processor 1930 may include one or more processors.

The transceiver 1910 is a collective term for a receiver and a transmitter of the UE and may transmit/receive a signal to/from a network entity, a base station, or another UE. The signal transmitted/received to/from the network entity, the base station, or the other UE may include control information and data. In this regard, the transceiver 1910 may include a RF transmitter for up-converting and amplifying a frequency of a transmitted signal, and a RF receiver for amplifying low-noise and down-converting a frequency of a received signal. However, this is only an example of the transceiver 1910 and components of the transceiver 1910 are not limited to the RF transmitter and the RF receiver.

In addition, the transceiver 1910 may receive and output, to the processor 1930, a signal through a wireless channel, and transmit a signal output from the processor 1930 through the wireless channel.

The memory 1920 may store a program and data required for operations of the UE. In addition, the memory 1920 may store control information or data included in a signal obtained by the UE. The memory 1920 may be a storage medium, such as read-only memory (ROM), random access memory (RAM), a hard disk, a CD-ROM, and a DVD, or a combination of storage media. In addition, the memory 1920 may not be present separately but may be included in the processor 1930.

The processor 1930 may control a series of processes such that the UE operates as described above. For example, the processor 1930 may receive a control signal and a data signal via the transceiver 1910 and process the received control signal and data signal. In addition, the processor 1930 may transmit the processed control signal and data signal to via the transceiver 1910. In addition, the processor 1930 may control the components of the UE to receive a plurality of physical downlink shared channels (PDSCHs) simultaneously by receiving downlink control information (DCI) including two layers.

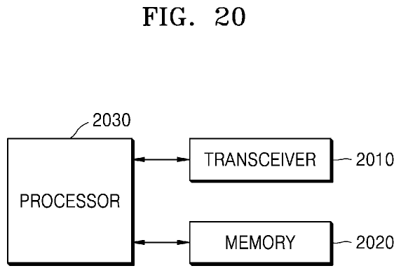

FIG. 20 is a block diagram of a configuration of a base station according to an embodiment of the disclosure.

Referring to FIG. 20, the base station may include a transceiver 2010, a memory 2020, and a processor 2030. The transceiver 2010, the memory 2020, and the processor 2030 of the base station may operate according to a communication method of the base station described above. However, the components of the base station are not limited thereto. For example, the base station may include more or fewer components than those described above. In addition, the transceiver 2010, processor 2030, and the memory 2020 may be implemented as a single chip. In addition, the processor 2030 may include one or more processors.

The transceiver 2010 collectively refers to a receiver and a transmitter of the base station, and may transmit/receive a signal to/from a UE or a network entity. The signal transmitted/received to/from the UE or network entity may include control information and data. In this regard, the transceiver 2010 may include a RF transmitter for up-converting and amplifying a frequency of a transmitted signal, and a RF receiver for amplifying low-noise and down-converting a frequency of a received signal. However, this is only an example of the transceiver 2010 and components of the transceiver 2010 are not limited to the RF transmitter and the RF receiver.

In addition, the transceiver 2010 may receive and output, to the processor 2030, a signal through a wireless channel, and transmit a signal output from the processor 2030 through the wireless channel.

The memory 2020 may store a program and data required for operations of the base station. In addition, the memory 2020 may store control information or data included in a signal obtained by the base station. The memory 2020 may be a storage medium, such as ROM, RAM, a hard disk, a CD-ROM, and a DVD, or a combination of storage media. In addition, the memory 2020 may not be present separately but may be included in the processor 2030.

The processor 2030 may control a series of processes such that the base station operates as described above. For example, the processor 2030 may receive a control signal and a data signal via the transceiver 2010 and process the received control signal and data signal. In addition, the processor 2030 may transmit the processed control signal and data signal to via the transceiver 2010. In addition, the processor 2030 may control each component of the base station to configure DCI including assignment information regarding a PDSCH and transmit the DCI.

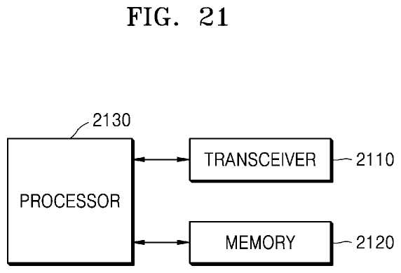

FIG. 21 is a block diagram of a configuration of a network entity according to an embodiment of the disclosure.

The network entity or NF described above may correspond to the network entity of FIG. 21. For example, a structure of OAM, AM, or NF may correspond to that of the network entity described in FIG. 21.

Referring to FIG. 21, the network entity may include a transceiver 2110, a memory 2120, and a processor 2130. The transceiver 2110, the processor 2130, and the memory 2120 of the network entity may operate according to the communication method of the network entity described above. However, the components of the network entity are not limited thereto. For example, the network entity may include more or fewer components than those described above. In addition, the transceiver 2110, processor 2130, and the memory 2120 may be implemented as a single chip. In addition, the processor 2130 may include one or more processors.

The transceiver 2110 collectively refers to a receiver and a transmitter of the network entity, and may transmit/receive a signal to/from a base station, a UE, or another network entity. The signal transmitted/received to/from the base station, UE, or network entity may include control information and data. In this regard, the transceiver 2110 may include a RF transmitter for up-converting and amplifying a frequency of a transmitted signal, and a RF receiver for amplifying low-noise and down-converting a frequency of a received signal. However, this is only an example of the transceiver 2110 and components of the transceiver 2110 are not limited to the RF transmitter and the RF receiver.

In addition, the transceiver 2110 may receive and output, to the processor 2130, a signal through a wireless channel, and transmit a signal output from the processor 2130 through the wireless channel.

The memory 2120 may store a program and data required for operations of the network entity. In addition, the memory 2120 may store control information or data included in a signal obtained by the network entity. The memory 2120 may be a storage medium, such as ROM, RAM, a hard disk, a CD-ROM, and a DVD, or a combination of storage media. In addition, the memory 2120 may not be present separately but may be included in the processor 2130.

The processor 2130 may control a series of processes such that the network entity operates as described above. For example, the processor 2130 may receive a control signal and a data signal via the transceiver 2110 and process the received control signal and data signal. In addition, the processor 2130 may transmit the processed control signal and data signal to via the transceiver 2110.

The methods according to the embodiments of the disclosure described in the claims or the detailed description of the disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in a device. The one or more programs include instructions to execute the methods according to the embodiments of the disclosure described in the claims or the detailed description.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network, such as the Internet, an intranet, a local area network (LAN), a wireless LAN (WLAN), or a storage area network (SAN), or a combination thereof. The storage device may be connected through an external port to an apparatus according to the embodiments of the disclosure. Another storage device on the communication network may also be connected to the apparatus performing the embodiments of the disclosure.

According to an embodiment of the disclosure, the base station may efficiently manage the data rate of the network slice by using configuration information received from at least one network entity from among an OAM, an NF, or an AMF.

In the afore-described embodiments of the disclosure, elements included in the disclosure are expressed in a singular or plural form according to the embodiments of the disclosure. However, the singular or plural form is appropriately selected for convenience of explanation and the disclosure is not limited thereto. As such, an element expressed in a plural form may also be configured as a single element, and an element expressed in a singular form may also be configured as plural elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network function (NF) in 5G core network (5GC) in a wireless communication system, the method comprising:
receiving, from an application function (AF), an event subscription request message comprising network slice related quota information for a network slice;
determining whether an event notification triggering condition for the network slice is met based on the network slice related quota information and data received from at least one NF in the 5GC; and
transmitting, to the AF, an event notification message for the network slice based on a result of the determining.

2. The method of claim 1, wherein the network slice related quota information for the network slice comprises at least one of a maximum number of user equipment (UEs) to be registered for the network slice or a maximum number of protocol data unit (PDU) sessions to be established for the network slice.

3. The method of claim 1, further comprising storing the network slice related quota information.

4. The method of claim 1, further comprising updating quota of the network slice based on the network slice related quota information.

5. The method of claim 2, further comprising:
monitoring a current number of UEs being registered for the network slice; and
determining whether the event notification triggering condition for the network slice is met based on the network slice related quota information and a result of the monitoring.

6. The method of claim 2, further comprising updating a current number of PDU sessions successfully established for the network slice based on the maximum number of PDU sessions to be established for the network slice.

7. The method of claim 2, wherein the event notification triggering condition comprises at least one of a first condition that a current number of UEs being registered for the network slice is equal to or greater than the maximum number of UEs to be registered for the network slice or a second condition that a current number of PDU sessions successfully established for the network slice is equal to or greater than the maximum number of PDU sessions to be established for the network slice.

8. The method of claim 2, wherein the network slice related quota information for the network slice further comprises a maximum data rate for the network slice.

9. The method of claim 1, wherein the NF is a policy control function (PCF).

10. The method of claim 1, wherein the data received from the at least one NF in the 5GC comprises at least one of each of a current number of UEs being registered for the network slice and supported by each of the at least one NF, respectively, or each of a current number of PDU sessions successfully established for the network slice and supported by each of the at least one NF, respectively.

11. A network function (NF) in 5G core network (5GC) in a wireless communication system, the NF comprising:
a transceiver; and
at least one processor operably coupled with the transceiver and configured to:
control the transceiver to receive, from an application function (AF), an event subscription request message comprising network slice related quota information for a network slice,
determine whether an event notification triggering condition for the network slice is met based on the network slice related quota information and data received from at least one NF in the 5GC, and
control the transceiver to transmit, to the AF, an event notification message for the network slice based on a result of the determining.

12. The NF of claim 11, wherein the network slice related quota information for the network slice comprises at least one of a maximum number of user equipment (UEs) to be registered for the network slice or a maximum number of protocol data unit (PDU) sessions to be established for the network slice.

13. The NF of claim 11, wherein the at least one processor is further configured to store the network slice related quota information.

14. The NF of claim 11, wherein the at least one processor is further configured to update quota of the network slice based on the network slice related quota information.

15. The NF of claim 12, wherein the at least one processor is further configured to:
monitor a current number of UEs being registered for the network slice, and
determine whether the event notification triggering condition for the network slice is met based on the network slice related quota information and a result of the monitoring.

16. The NF of claim 12, wherein the at least one processor is further configured to update a current number of PDU sessions successfully established for the network slice based on the maximum number of PDU sessions to be established for the network slice.

17. The NF of claim 12, wherein the event notification triggering condition comprises at least one of a first condition that a current number of UEs being registered for the network slice is equal to or greater than the maximum number of UEs to be registered for the network slice or a second condition that a current number of PDU sessions successfully established for the network slice is equal to or greater than the maximum number of PDU sessions to be established for the network slice.

18. The NF of claim 12, wherein the network slice related quota information for the network slice further comprises a maximum data rate for the network slice.

19. The NF of claim 11, wherein the NF is a policy control function (PCF).

20. The NF of claim 11, wherein the data received from the at least one NF in the 5GC comprises at least one of each of a current number of UEs being registered for the network slice and supported by each of the at least one NF, respectively, or each of a current number of PDU sessions successfully established for the network slice and supported by each of the at least one NF, respectively.
